(19) United States
(12) Patent Application Publication
(10) Pub. No.: US 2023/0123012 A1
(43) Pub. Date: Apr. 20, 2023

(54) CURABLE ADHESIVE BASED ON SILANE FUNCTIONALIZED RESIN

(71) Applicant: Synthomer Adhesive Technologies LLC, Beachwood, OH (US)

(72) Inventors: Thauming Kuo, Kingsport, TN (US); Michaela Hofbauer, Kingsport, TN (US); Liu Deng, Kingsport, TN (US); Mark Thomas Arigo, Hudson, OH (US); Timothy Harold Blayney, Piney Flats, TN (US); Terri Roxanne Carvagno, Church Hill, TN (US); Stephen Franklin Hatfield, Kingsport, TN (US); Mark William Ingratta, Copley, OH (US); Rui Xie, Pearland, TX (US)

(21) Appl. No.: 18/045,020

(22) Filed: Oct. 7, 2022

Related U.S. Application Data
(60) Provisional application No. 63/262,260, filed on Oct. 8, 2021.

(51) Int. Cl. C09J 7/30; C08F 212/14; C08F 212/08; C08F 230/08; C08G 63/91; C08K 5/544

(52) U.S. Cl. CPC C09J 7/30; C08F 212/28; C08F 212/24; C08F 212/08; C08F 230/085; C08G 63/916; C08K 5/544; C09J 2425/00; C09J 2467/00; C09J 2301/304; C09J 2301/414

(57) ABSTRACT

Disclosed are curable adhesive compositions comprising hydroxyl functional polymers and silane functionalized resins. Such adhesive compositions are capable of providing unexpected properties for various uses and end products. The adhesive may be used for woodworking, automotive, textile, appliances, electronics, bookbinding, and packaging. Suitable substrates can be metal, polymer film, plastics, wood, glass, ceramic, paper, and concrete.

### CROSS REFERENCE TO RELATED APPLICATION

This application claims priority of U.S. provisional patent application No. 63/262,260, filed Oct. 8, 2021, the entire content of which is incorporated herein by reference.

### BRIEF SUMMARY

It is an object to provide a curable adhesive composition. The object is, for example, achieved by a curable adhesive composition comprising a hydroxyl functional polymer, and a silane functionalized resin. In the composition, the hydroxyl functional polymer has a hydroxyl number of 10 mgKOH/g to 200 mgKOH/g and number average molecular weight of 500 g/mol to 10,000 g/mole, and the silane functional hydrocarbon resin is represented by the structure of:

Resin-[Zₖ—Xₙ—R¹—(CH₂)ₘ—Si(R²)ₚ]_{q}

In this structure, Z is an aromatic group or an aliphatic group; X is a linker comprising a heteroatom selected from sulfur, oxygen, nitrogen, a carbonyl group, or a combination thereof; R¹ comprises one or more of an aliphatic and/ or aromatic C₁ to C₁₈ and/or a linkage group comprising a heteroatom; each R2 is the same or different and is independently selected from a C₁ to C₁₈ alkoxy, aryloxy, alkyl, aryl, or H, or OH, and is optionally branched, and at least one R2 is C1 to C₁₈ alkoxy, aryloxy, or H, or OH; q is an integer from of at least 1; k is an integer of 0 or 1; n is an integer from 1 to 10; m is an integer from 0 to 10; p is 1, 2, or 3; and the silane functionalized resin forms a Si—O—C covalent bond with the hydroxyl functional polymer upon curing of said adhesive. In certain embodiments, Z is a heteroatom.

Such compositions, in some embodiments, possess a peel strength of 5 N/25 mm or greater as measured in accordance with ASTM D1876 (T-peel test) or ISO 4587, a lap shear strength of 1 N/mm2 or greater as measured in accordance with ASTM D1002, and/or an offline bond strength of from 100 grams per 25 mm to 1000 grams per 25 mm as measured in accordance with ASTM F904-16, after the curable adhesive composition is fully cured between two substrates.

In certain embodiments of the composition, the hydroxyl functional polymer is present in an amount of 30 weight % to 90 weight %, and the silane functionalized resin is in an amount of 10 weight % to 70 weight %, based on the total weight. In other embodiments, the hydroxyl functional polymer comprises hydroxyl groups, and wherein the hydroxyl groups are present in the composition in a ratio of 0.7 to 1.3 with respect to silane groups.

In certain alternative embodiments, the hydroxyl functional polymer is one or more of polyester polyol, polyether polyol, and acrylic polyol. In certain embodiments wherein the hydroxyl functional polymer is a polyester polyol and further comprises at least one diol, at least one diacid, and/or at least one polyol. In such embodiments, for instance, the at least one diol is one or more of 2,2,4,4-tetramethyl-1,3-cyclobutanediol (TMCD), 2,2-dimethyl-1,3-propanediol (neopentyl glycol), 1,2 cyclohexane¬dimethanol, 1,3-cyclohexanedimethanol, 1,4 cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, tetraethylene glycol, polyethylene glycol, and 2,2-bis(hydroxymethyl)propionic acid (dimethylolpropionic acid). In such embodiments, for instance, the at least one polyol is one or more of 1,1,1-trimethylolpropane (TMP), 1,1,1-trimethylolethane, glycerin, pentaerythritol, erythritol, threitol, dipentaerythritol, and sorbitol. In such embodiments, the at least one diacid is selected from one or more of a dimethyl ester, a dialkyl ester, a diacid halide, or an acid anhydride or is one or more of isophthalic acid (or dimethyl isophthalate), terephthalic acid (or dimethyl terephthalate), phthalic acid, phthalic anhydride, 1,4 cyclohexane-dicarboxylic acid, 1,3 cyclohexanedicarboxylic acid, hexahydrophthalic anhydride, tetrahydrophthalic anhydride, tetrachlorophthalic anhydride, dodecanedioic acid, sebacic acid, azelaic acid, maleic acid or anhydride, fumaric acid, succinic anhydride, succinic acid, adipic acid, dimer acid, hydrogenated dimer acid, 2,6 naphthalenedicarboxylic acid, glutaric acid, itaconic acid, and their derivatives, diglycolic acid, 2,5-norbornanedicarboxylic acid, 1,4-naphthalenedicarboxylic acid; 2,5-naphthalenedicarboxylic acid, diphenic acid; 4,4′-oxydibenzoic acid, and 4,4′-sulfonyidibenzoic acid.

In alternative embodiments, the composition further comprises an organic solvent. In some embodiments the composition is a hot melt adhesive.

In various alternative embodiments, the composition is cured, wherein curing comprises hydrolysis of alkoxy groups on silane groups in the silane functionalized resin to yield silanol groups, and condensation reaction with hydroxyl groups on the hydroxyl functional polymer to form Si—O—C covalent bonds or with other silanol groups to form Si—O—Si covalent bonds.

In various alternative embodiments, the composition further comprises at least one vinyl polymer selected from one or more of methyl acrylate, methyl methacrylate, ethyl acrylate, ethyl methacrylate, butyl acrylate, butyl methacrylate, isobutyl acrylate, isobutyl methacrylate, 2-ethylhexyl methacrylate, 2-ethylhexyl acrylate, isoprene, octyl acrylate, octyl methacrylate, iso-octyl acrylate, iso-octyl methacrylate, isobornyl (meth)acrylate, cyclohexyl (meth)acrylate, hydroxymethyl (meth)acrylate, hydroxyethyl (meth)acrylate, hydroxypropyl (meth)acrylate, hydroxylbutyl (meth)acrylate, acetoacetoxy ethyl methacrylate, acetoacetoxy ethyl acrylate, methyl 2-(hydroxymethyl)acrylate, ethyl 2-(hydroxymethyl)acrylate, isopropyl 2-(hydroxymethyl)acrylate, n-butyl 2-(hydroxymethyl)acrylate, t-butyl 2-(hydroxymethyl)acrylate, vinyl ester such as vinyl acetate, vinyl alcohol, vinyl ether, styrene, alkylstyrene, butadiene, and acrylonitrile.

Also provided are articles comprising the composition, such articles include, for instance, a laminate, a tape, a tag, a radio frequency identification (RFID) tag, a sealant, a flexible or non-flexible film, a foam, a potting compound, a disposable hygiene article, a fiberglass reinforced plastic, a motor vehicle molded part, a motor vehicle extruded part, a motor vehicle laminated part, a furniture part, a fabric, or a woven textile.

### DETAILED DESCRIPTION

This invention relates to silane functionalized resins as crosslinkers for polyols, such as polyester polyol, polyether polyol, and acrylic polyol to provide curable compositions. One end use of the curable compositions is for adhesive application.

In one embodiment of the invention, there is provided a curable adhesive composition comprising:
a. a hydroxyl functional polymer and
b. a silane functionalized resin,
   wherein the hydroxyl functional polymer has a hydroxyl number of 10-200 mgKOH/g and number average molecular weight of 500-10,000 g/mole, and wherein said silane functionalized resin is represented by the structure of:

resin-[Zₖ—Xₙ—R¹—(CH₂)ₘ—Si(R²)ₚ]_{q}

wherein Z is an aromatic group or an aliphatic group, optionally comprising a heteroatom;

wherein X is a linker comprising a heteroatom selected from sulfur, oxygen, nitrogen, a carbonyl group, or a combination thereof;

wherein R¹ comprises one or more of an aliphatic and/ or aromatic C₁ to C₁₈ and/or a linkage group comprising a heteroatom;

wherein each R² is the same or different and is independently selected from a C₁ to C₁₈ alkoxy, aryloxy, alkyl, aryl, or H, or OH, and is optionally branched, and wherein at least one R² is C₁ to C₁₈ alkoxy, aryloxy, or H, or OH;
wherein q is an integer from of at least 1;
wherein k is an integer of 0 or 1;
wherein n is an integer from 1 to 10;
wherein m is an integer from 0 to 10;
wherein p is 1, 2, or 3; and
   wherein the silane functionalized resin formed a Si—O—C covalent bond with the hydroxyl functional polymer upon curing of said adhesive.

The silane functionalized resins suitable for this invention have been disclosed in U.S. Pat. No.10,815,320 B2, the content of which is incorporated herein in its entirely. The preparation of such silane functionalized resins is further illustrated in the Example section.

In another embodiment, said hydroxyl functional polymer (a) is in an amount of 30-90 weight % and said silane functionalized resin (b) is in an amount of 10-70 weight %, based on the total weight of (a) and (b). In some embodiments, the hydroxyl functional polymer is in 40-80, 50-80, 60-80, 70-80, 50-70, or 50-60 weight % and the silane functionalized resin is in 20-60, 20-50, 20-40, 20-30, 30-50, or 40-50 weight %.

Desirably, the equivalent ratio of hydroxyl (OH) and silane functionalities is OH/silane=0.7 to 1.3, 0.8 to 1.2, 0.9 to 1.1, or 0.95 to 1.05.

Silane functionalized resins having 2 or more silane groups are particularly suitable for the curable composition of the invention as they can provide more reactive sites for effective crosslinking.

The curing of the adhesive composition is triggered by the hydrolysis of the alkoxy groups on the silane group to yield silanol groups, which then undergo condensation reaction either with the hydroxyl groups on the hydroxyl functional polymer to form Si—O—C covalent bonds or with other silanol groups to form Si—O—Si covalent bonds. The curing can occur at room temperatures over time in the presence of moisture in air. The curing can also be accelerated by heat and/or by adding a catalyst for the hydrolysis and condensation reactions.

When fully cured between two substrates, the adhesive of the invention has either a peel strength of 5 N/25 mm or greater as measured in accordance with ASTM D1876 (T-peel test) (suitable for flexible substrates) or ISO 4587, or a lap shear strength of 1 N/mm² or greater as measured in accordance with ASTM D1002 (suitable for rigid substrates).

In some embodiments, the adhesive of the invention has either a peel strength of 5, 10, 20, 30, 40, or 50 N/25 mm or greater as measured in accordance with ASTM D1876 (T-peel test) (suitable for flexible substrates) or ISO 4587, or a lap shear strength of 1, 5, 10, 20, 30, 40, or 50 N/mm² or greater as measured in accordance with ASTM D1002 (suitable for rigid substrates).

Adhesive compositions described herein may exhibit unique and desirable properties such as, for example, improved cure time, green bond strength, solvent resistance, chemical resistance, hydrolytic stability, thermal stability, impact resistance, weatherability, improved applicability, as compared to conventional adhesive compositions. Such adhesive compositions as described herein may be of several types and may be suitable for a wide array of end uses, such as, for example, flexible packaging, automotive, building and construction, wood working, assembly adhesives, wood adhesives, electronic component adhesives, and potting compounds for electronics.

Examples of said hydroxyl functional polymer (a) include polyester polyol, polyether polyol, acrylic polyol, and mixtures thereof. Polyester polyol includes a diol component and a diacid component, and optionally a polyol component. The diol has 2 hydroxyl groups and can be branched or linear, saturated or unsaturated, aliphatic or cycloaliphatic C₂-C₂₀ compounds, the hydroxyl groups being primary, secondary, and/or tertiary, desirably primary. Examples of diols include 2,2,4,4-tetramethyl-1,3-cyclobutanediol (TMCD), 2,2-dimethyl-1, 3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1, 6-hexanediol, 1,10-decanediol, 1,4-benzenedimethanol, ethylene glycol, propylene glycol, diethylene glycol, dipropylene glycol, triethylene glycol, tetraethylene glycol, polyethylene glycol, and 2,2-bis(hydroxymethyl)propionic acid (dimethylolpropionic acid).

Desirably, the diol is selected from 2,2,4,4-tetramethyl-1,3-cyclobutanediol (TMCD), 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 1,4-butanediol, and 1,6-hexanediol or mixtures thereof.

The polyol having 3 or more hydroxyl groups can be branched or linear, saturated or unsaturated, aliphatic or cycloaliphatic C₂-C₂₀ compounds, the hydroxyl groups being primary, secondary, and/or tertiary, and desirably at least two of the hydroxyl groups are primary. Desirably, the polyols are hydrocarbons and do not contain atoms other than hydrogen, carbon and oxygen. Examples of the polyol include 1,1,1-trimethylolpropane (TMP), 1,1,1-trimethylolethane, glycerin, pentaerythritol, erythritol, threitol, dipentaerythritol, sorbitol, mixtures thereof, and the like. Desirably, the polyol is TMP.

The diacid may be a dicarboxylic acid compound, a derivative of dicarboxylic acid compound, or a combination thereof. In one aspect, the dicarboxylic acid compound comprises a dicaraboxylic acid compound having two carboxylic acid groups, derivatives thereof, or combinations thereof, capable of forming an ester linkage with a hydroxyl component. For example, a polyester can be synthesized by using a dihydroxyl compound and a derivative of a dicarboxylic acid such as, for example, dimethyl ester or other dialkyl esters of the diacid, or diacid chloride or other diacid halides, or acid anhydride. Examples of dicarboxylic acids that may be used include aliphatic dicarboxylic acids, alicyclic dicarboxylic acids, aromatic dicarboxylic acids, derivatives of each, or mixtures of two or more of these acids. Thus, suitable dicarboxylic acids include, but are not limited to, isophthalic acid (or dimethyl isophthalate), terephthalic acid (or dimethyl terephthalate), phthalic acid, phthalic anhydride, 1,4-cyclohexane-dicarboxylic acid, 1 ,3-cyclohexanedicarboxylic acid, hexahydrophthalic anhydride, tetrahydrophthalic anhydride, tetrachlorophthalic anhydride, dodecanedioic acid, sebacic acid, azelaic acid, maleic acid or anhydride, fumaric acid, succinic anhydride, succinic acid, adipic acid, dimer acid, hydrogenated dimer acid, 2,6-naphthalenedicarboxylic acid, glutaric acid, itaconic acid, and their derivatives, diglycolic acid; 2,5-norbornanedicarboxylic acid; 1,4-naphthalenedicarboxylic acid; 2,5-naphthalenedicarboxylic acid; diphenic acid; 4,4′-oxydibenzoic acid; 4,4′-sulfonyidibenzoic acid, and mixtures thereof.

The hydroxyl number of the polyester suitable for the present invention is from about 10 to about 200, from about 30 to about 180, or from about 50 to about 150 mgKOH/g. The acid number is from 0 to about 30, from about 0 to about 20, from 0 to about 10, or from 0 to about 5 mgKOH/g.

The number average molecular weight (Mn) of the polyester suitable for the present invention may be from 500 to 10,000, from 800 to 6,000, or from 1,000 to 3,000 g/mole. The weight average molecular weight (Mw) of the polyester may be from 1,000 to 100,000, from 1,500 to 50,000, or from 2,000 to 10,000 g/mole. Molecular weights are measured by gel permeation chromatography (GPC) using polystyrene equivalent molecular weight.

The glass transition temperature (Tg) of the polyester suitable for the present invention may be from −70° C. to 120° C., from −60° C. to −20° C., from −40° C. to −10° C., from −30° C. to 10° C., from −10° C. to 20° , from 0° C. to 30° C., from 20° C. to 50° C., from 30° C. to 60° C., from 40° C. to 70° C., from 50° C. to 80° C., or from 60° C. to 100° C.

Additionally, or in the alternative, the adhesive composition may comprise at least one polyether polyol. Examples of suitable polyether polyols include, but are not limited to, Voranol 2120 and 2000LM (commercially available from Dow Chemical). In some embodiments, the polyether polyol may be used in an amount of 0, or at least about 5, at least about 10, at least about 15, at least about 20, at least about 25, at least about 30, at least about 35 and/or not more than about 55, not more than about 50, not more than about 45, not more than about 40, not more than about 35, not more than about 30, or not more than about 25 weight percent, based on the total weight of the composition.

Additionally, or in the alternative, the adhesive composition may further comprise one or more reactive or non-reactive vinyl polymers to further improve the desirable properties such as cure time, bond strength, cohesion, and mechanical strength. Examples of such vinyl polymers include homopolymers and copolymers of ethylenically unsaturated monomers selected from the group comprising methyl acrylate, methyl methacrylate, ethyl acrylate, ethyl methacrylate, butyl acrylate, butyl methacrylate, isobutyl acrylate, isobutyl methacrylate, 2-ethylhexyl methacrylate, 2-ethylhexyl acrylate, isoprene, octyl acrylate, octyl methacrylate, iso-octyl acrylate, iso-octyl methacrylate, isobornyl (meth)acrylate, cyclohexyl (meth)acrylate, hydroxymethyl (meth)acrylate, hydroxyethyl (meth)acrylate, hydroxypropyl (meth)acrylate, hydroxylbutyl (meth)acrylate, acetoacetoxy ethyl methacrylate, acetoacetoxy ethyl acrylate, methyl 2-(hydroxymethyl)acrylate, ethyl 2-(hydroxymethyl)acrylate, isopropyl 2-(hydroxymethyl)acrylate, n-butyl 2-(hydroxymethyl)acrylate, t-butyl 2-(hydroxymethyl)acrylate, vinyl ester such as vinyl acetate, vinyl alcohol, vinyl ether, styrene, alkylstyrene, butadiene, and acrylonitrile. The reactive vinyl polymers can have functionalities such as, for example, hydroxyl, acetoacetate, and carbamate. The vinyl polymers may be used in various adhesive formulations including solvent-borne, solventless, and hot melt types.

The adhesive composition may also include one or more other components such as, for example, a tackifier. The tackifier may help improve the adhesive properties, including but not limited to the viscosity, wetting behavior, green bond strength, adhesion, particularly to low energy surfaces, and viscoelastic behavior of the finished adhesive composition. The tackifier resin selected may vary depending on the exact curable composition and the balance of properties needed in an application, such as peel strength, shear strength, and tack.

Tackifier resins that may be present in the adhesive compositions described herein may include, but are not limited to, cycloaliphatic hydrocarbon resins, C5 hydrocarbon resins, C5/C9 hydrocarbon resins, aromatically modified C5 resins (commercially available as Piccotac198 resins, Eastman Chemical Company, Tenn., U.S.), C9 hydrocarbon resins (commercially available as Picco™ resins, Eastman), pure monomer resins (e.g., copolymers of styrene with alpha-methyl styrene, vinyl toluene, para-methyl styrene, indene, and methyl indene) (commercially available as Kristalex™ resins, Eastman), DCPD resins, dicyclopentadiene based/containing resins, cyclo-pentadiene based/containing resins, terpene resins (commercially available as Sylvares™ resins, AZ Chem Holdings, LP, Jacksonville, Fla., U.S.), terpene phenolic resins, terpene styrene resins, esters of rosin (commercially available as Permalyn™ resins, Eastman), esters of modified rosins, liquid resins of fully or partially hydrogenated rosins, fully or partially hydrogenated rosin esters (commercially available as Foral™ and Foralyn™ resins, Eastman), fully or partially hydrogenated modified rosin resins, fully or partially hydrogenated rosin alcohols, fully or partially hydrogenated rosin acids (commercially available as Staybelite™, Foral™ and Foralyn™ resins, Eastman), fully or partially hydrogenated C5 resins, fully or partially hydrogenated C5/C9 resins, fully or partially hydrogenated DCPD resins (commercially available as Escorez® 5000-series resin, ExxonMobil Chemical Company, Tex., U.S.), fully or partially hydrogenated dicyclopentadiene based/containing resins, fully or partially hydrogenated cyclo-pentadiene based/containing resins, fully or partially hydrogenated aromatically modified C5 resins, fully or partially hydrogenated C9 resins (commercially available as RegaliteTM resins, Eastman), fully or partially hydrogenated pure monomer resins (e.g., copolymers or styrene with alpha-methyl styrene, vinyl toluene, para-methyl styrene, indene, and methyl indene) (commercially available as Regalrez™ resins, Eastman), fully or partially hydrogenated C5 cycloaliphatic resins (commercially available as Eastotac™ resins, Eastman), fully or partially hydrogenated C5/cycloaliphatic/styrene/C9 resins, fully or partially hydrogenated cycloaliphatic resins, and mixtures thereof.

When present, the tackifier may also include, for example, rosin esters, such as glycerol rosin ester, pentaerythritol rosin ester, and hydrogenated rosin resins, and hydrocarbon resins. In some embodiments, the adhesive of the present invention may further comprise one or more catalysts or activating agents selected from the group comprising Brönstedt and/or Lewis acids, such as acetic acid, dibutyltin oxide, dibutyltin dilaurate, dibutyltin diacetylacetonate, bismuth carboxylate, zinc oxide, titanium (IV) oxide, titanium acetylacetonate, and basic catalysts such as triethylamine and ammonium hydroxide.

The adhesive of the invention may further comprise a solvent. Examples of suitable solvents include, but are not limited to, ethyl acetate, n-butyl acetate, isobutyl acetate, t-butyl acetate, n-propyl acetate, isopropyl acetate, methyl acetate, ethanol, n-propanol, isopropanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, ethyl-3-ethoxypropionate, xylene, toluene, acetone, methyl amyl ketone, methyl isoamyl ketone, methyl ethyl ketone, cyclopentanone, and cyclohexanone.

When a solvent is present, the adhesive may have a solids content of at least about 10, at least about 15, at least about 20, at least about 25, at least about 30, at least about 35, at least about 40, or at least about 45 weight percent and/or less than about 90, not more than about 85, not more than about 80, not more than about 75, not more than about 70, not more than about 65, not more than about 60, not more than about 55, not more than about 50, or not more than about 45 percent, based on the total weight of the adhesive composition.

In some embodiments, the adhesive composition can be a hot melt adhesive. When the adhesive is a hot melt, it may comprise a solventless or solid composition and may be heated during all or a portion of its application. When the adhesive composition is solventless, it may have a solids content of at least about 90, at least about 92, at least about 95, at least about 97, at least about 99, or at least about 99.5 weight percent, based on the total weight of the adhesive. Solventless adhesives may be in the form of pellets, powders, sticks, or other masses solid at room temperature and pressure.

When the adhesive composition is a hot melt adhesive, it may be applied by heating the adhesive to a temperature of at least about 50, at least about 55, at least about 60, at least about 65, at least about 70, at least about 75, at least about 80, at least about 85, at least about 90, at least about 95, at least about 100, at least about 105, at least about 110, at least about 115, at least about 120, at least about 125, at least about 130, at least about 135, or at least about 140° C. and/or not more than about 200, not more than about 195, not more than about 190, not more than about 185, not more than about 180, not more than about 175, not more than about 170, not more than about 165, not more than about 160, not more than about 155, or not more than about 150° C. Hot melt adhesive compositions according to embodiments of the invention can be single component or two-component adhesives. Typical methods of applying the hot melt adhesive include, but are not limited to, a roll coater, sprayer, or a glue gun.

Adhesive compositions as described herein may have enhanced properties as compared to adhesives formulated with conventional polyols. For example, adhesive compositions according to embodiments of the present invention may have both greater initial bond strength (offline bond strength), as well as higher levels of both thermal and chemical resistance. This makes the adhesives suitable for a variety of end use applications, from woodworking to electronics to flexible packaging and automotive finishes. Such adhesives exhibit high offline bond strength, quickly reach substrate failure, have a high chemical and thermal resistance.

In some embodiments, adhesive compositions as described herein may have an offline bond strength in the range of from 100 to 1000 grams per 25 mm. Offline Bond Strength is measured according to ASTM F904-16 immediately after lamination. The offline bond strength exhibited by the present invention can be at least about 150, at least about 200, at least about 250, at least about 300, at least about 350, at least about 400, at least about 450, at least about 500, or at least about 550 and/or not more than about 1000, not more than about 950, not more than about 900, not more than about 850, not more than about 800, not more than about 750, not more than about 700, not more than about 650, or not more than about 600 g/25 mm.

According to embodiments of the present invention, there is provided a method of using the adhesive compositions described herein. The method comprises contacting a surface of at least one layer or substrate with at least a portion of an adhesive composition, then adhering another layer or substrate to the first via the adhesive layer. The adhesive composition used to form the adhesive layer may be any adhesive composition as described herein or can be a composition comprising the inventive silane functionalized rosin.

Additionally, there is provided a laminated article formed from an adhesive described herein comprising a first substrate presenting a first surface, a second substrate presenting a second surface, and an adhesive layer disposed between and partially in contact with at least one of the first and second surfaces. Each of the first and second layers may comprise a material selected from the group consisting of polyethylene terephthalate, polypropylene, aluminum-coated or aluminum-laminated polyethylene terephthalate, low density polyethylene, and combinations thereof. In some cases, the first and second layers may be the same, while, in other embodiments, the first and second substrates or layers may be different (or formed from different materials).

In some embodiments, one or both of the first and second layers may have a thickness of at least about 0.5, at least about 1, at least about 1.5, or at least about 2 mil (1 mil=25 μm) and/or not more than about 10, not more than about 8, not more than about 5, not more than about 3, not more than about 2, or not more than about 1.5 mil. The laminated article may further comprise a third, fourth, fifth, or even sixth layer, each separated from and in contact with, at least one additional adhesive layer, at least one of which is formed from an adhesive composition as described herein.

In some embodiments, the laminated article, or film, may be used to form another article such as, for example, a package, pouch, bag, or other type of container for holding and storing at least one substance, such as, for example, an edible item. The package, pouch, bag, or other container may then be filled with at least one substance, such as, for example, a foodstuff, beverage, or other edible substance, which can then be sealed within the interior volume of the package. As discussed previously, such a package may exhibit enhanced chemical and thermal resistance to delamination or other types of failure, due to the enhanced performance of the adhesive used to form the laminate.

In another embodiment, there is provided a laminated article comprising a first substrate presenting a first surface, a second substrate presenting a second surface, and an adhesive layer disposed between and in contact with at least a portion of the first and second surfaces. The substrates may be selected from the group consisting of polymers (including, but not limited to, polymeric foams and thicker or rigid polymeric substrates such as polycarbonate), wood, metal, fabric, leather, and combinations thereof. The first and second substrates may be formed from the same material or each may be formed from a different material.

In some embodiments, the first and second substrates may have different thicknesses such that, for example, one substrate is relatively thick (e.g., 6 mm or more), while the other is relative thin (e.g., not more than 0.75 mm). Such differences in thickness may occur when, for example, an adhesive composition is used to adhere an outer decorative or functional layer to a base substrate. In some cases, the ratio of the thickness of the thinner substrate to the thicker substrate can be at least about 0.0001:1, at least about 0.0005:1, at least about 0.001:1, at least about 0.005:1, at least about 0.01:1, at least about 0.05:1, at least about 0.1:1, at least about 0.5:1, or at least about 0.75:1.

Examples of suitable end use applications for adhesives as described herein can include, but are not limited to, woodworking, automotive, textile, appliances, electronics, bookbinding, and packaging. Suitable substrates can be metal, polymer film, plastics, wood, glass, ceramic, paper, and concrete.

In various embodiments, the curable adhesive compositions can be applied in the range of about 0.5 gsm to about 200 gsm (gsm=grams per square meter). In embodiments where the curable composition will be used to bond substrates to each other, the add-on rate used will be suitable for generating laminates or composites with the desired bond strength. The curable composition can be applied to one or both substrates before the substrates are brought into contact to form a composite, laminate or article. The article so formed may be optionally contacted with additional substrates, additional curable compositions, adhesives, and/or may be subjected to applied pressure and/or applied heat, in any order or combination without limitation.

In one embodiment of the invention, there is provided a process for preparing and curing a reactive adhesive comprising preparing a composition of the invention for a reactive adhesive and applying heat from an external source at a temperature above or at ambient temperature to said composition, whereby polymerization is initiated.

In one embodiment of the invention, there is provided a process for forming a laminate structure, comprising the following steps: (1) forming an adhesive composition by combining the three components of any of the compositions of the invention; (2) applying the adhesive composition to a surface of a first substrate; thereby forming the laminate structure.

In one embodiment, an article of manufacture is provided comprising at least one flexible substrate coated with at least one composition of the invention.

In one embodiment, an article of manufacture is provided comprising at least two substrates wherein said substrates comprise flexible film and wherein between said substrates of flexible film is at least one of the compositions of the invention which has cured.

In one embodiment of the invention, the article of manufacture of the invention can be a laminated structure.

In one embodiment of the invention, there is provided a process wherein at least one adhesive composition of the invention can be applied to a first substrate and a second substrate which can be each independently selected from the group consisting of a wood material, a metallic material, a plastic material, an elastomeric material, a composite material, a paper material, a fabric material, a glass material, a foamed material, a metal, a mesh material, a leather material, a synthetic leather material, a vinyl material, poly(acrylonitrile butadiene styrene) (ABS), polypropylene (PP), glass filled PP, talc filled PP, impact-modified PP, polycarbonate (PC), PC-ABS, urethane elastomers, thermoplastic polyolefin (TPO) compounds, pigmented TPO compounds, filled TPO compounds, rubber-modified TPO compounds, a primed (painted) material, or combinations of two or more thereof.

In one embodiment of this invention, there is provided a process wherein at least one composition of the invention can be applied to a first substrate and, optionally, can be applied to a second substrate wherein a first substrate and a second substrate can be each independently selected from the group consisting of poly(acrylonitrile butadiene styrene) (ABS); polycarbonate (PC); PC-ABS blends; thermoplastic polyolefins such as polypropylene (PP); textiles, e.g., fabric materials, mesh, wovens, and/or nonwovens; foam materials; leather materials; vinyl materials; and/or others that would be apparent to one of ordinary skill in the art. These materials can be used with or without fillers such as talc, glass, etc. as described herein.

In one embodiment of the invention, there is process wherein at least one adhesive composition of the invention can be applied to a first substrate and, optionally, can be applied to a second substrate and can be each independently selected from a polyester composite, a glass composite, or a wood-plastic composite.

In one embodiment of the invention, there is provided a process wherein at least one adhesive composition of the invention can be applied to a first substrate and, optionally, can be applied to a second substrate which are each independently selected from the group consisting of cast polypropylene, metallized polypropylene, foil laminated polypropylene, polyethylene terephthalate (PET), metallized PET, foil laminated PET, oriented PET, biaxially oriented PET, extruded PET, low density polyethylene (LDPE), oriented polypropylene, biaxially oriented polypropylene (BOPP), nylon, ethylene vinyl alcohol, and extruded films.

In one embodiment, there is provided an article of manufacture comprising at least one composition of the invention and/or processed by any of the processes of the invention.

In one embodiment, there is provided an article of manufacture comprising at least one composition of the invention and further comprising one or more substrates, e.g., flexible substrates, assembly part substrates, automobile interior substrates, woodworking substrates, furniture part substrates, etc. “Flexible substrate” is defined herein as a substrate that is less than 10 mil thick.

In one embodiment, there is provided an article of manufacture comprising at least two substrates wherein at least one composition of the invention is applied to the first substrate and wherein the second substrate can be contacted with said composition.

In one embodiment, there is provided an article of manufacture which is layered with multiple substrates wherein at least one composition of the invention is layered between at least two of said substrates.

In one embodiment, there is provided an article of manufacture comprising at least one composition of the invention which is a laminate structure.

In one embodiment, there is provided an article of manufacture wherein at least one composition of the invention is applied to at least one surface of a multi-laminated structure.

In one embodiment, there is provided an article of manufacture comprising at least one composition of the invention selected from the group consisting of: an adhesive, a laminate, a tape, a label, a tag, a radio frequency identification (RFID) tag, a coating, a sealant, a film (whether or not flexible), a foam, a potting compound, a disposable hygiene article, a polyester composite, a glass composite, a fiberglass reinforced plastic, a wood-plastic composite, an extruded compound, a polyacrylic blended compound, a potting compound, a rubber compound, a motor vehicle molded part, a motor vehicle extruded part, a motor vehicle laminated part, a furniture part, sheet molding compound (SMC), dough molding compound (DMC), textiles (e.g. fabric materials, mesh, wovens and/or nonwovens) and/or a flexible packaging multilayer.

In one embodiment, the substrates used in the articles of manufacture of the invention can be flexible film substrates comprising at least one composition of the invention.

In one embodiment, the articles of manufacture of the invention can be assembly parts including but not limited to automobile parts, woodworking parts, and/or furniture parts comprising at least one composition of the invention.

In one embodiment, the article of manufacture of the invention can comprise an adhesive. The adhesive compositions of the invention can comprise any one of the compositions of the invention. In one embodiment, the adhesive compositions of the invention can be reactive adhesives. In one embodiment, the adhesive compositions of the invention can be curable or cured.

In one embodiment, any of the adhesive compositions of the invention can be applied to a substrate at any thickness known in the art for a particular application, for example, from about 0.5 microns to about 50 microns, or from about 0.5 microns to 5 microns, for example, for some flexible packaging applications.

In one embodiment, any of the adhesive compositions of the invention can be applied to a substrate at any thickness known in the art for a particular application, including but not limited to 50 to 200 microns or 50 to 150 microns or 75 to 125 microns, for example, for some assembly applications such as auto assembly or woodworking assembly.

The compositions of this invention can provide desirable properties for a variety of applications. In certain embodiments, the compositions of this invention are suitable for applications in the adhesives area, for example, automotive adhesives, structural adhesives, wood adhesives, and laminating adhesives, and applications in the coatings area, for example, automotive, industrial maintenance, marine craft, field-applied coatings, and furniture.

In one embodiment, any of the adhesive compositions of the invention can be selected from at least one of the following: automotive interior adhesive, flexible laminating adhesive, rigid laminating adhesive, assembly adhesive, labelling adhesive, nonwoven adhesive, tape adhesive, structural adhesive, hygiene nonwoven construction adhesive, hygiene elastic attachment adhesive, home repair adhesive, industrial adhesive, construction adhesive, furniture adhesive, medical adhesive, contact adhesive, hot melt adhesive, solvent-based adhesive, packaging adhesive, product assembly adhesive, woodworking adhesive, flooring adhesive, automotive assembly adhesive, structural adhesive, pressure sensitive adhesive (PSA), PSA tape, PSA label, PSA protective film, laminating adhesive, flexible packaging adhesive, hygiene core integrity adhesive, packaging adhesive, and hygiene core integrity adhesive.

In some embodiments, such as pressure sensitive adhesives, the curable compositions of the present invention can be characterized by adhesive strength by 180-degree peel test e.g. according to ISO 8510-2-2006 Part 2 at 5 mm/sec or PSTC-101, cohesive strength and/or temperature resistance by static shear hold power testing (room temperature or elevated temperature, e.g., 40° C. or 70° C.) by PSTC-107 and/or by shear adhesion failure temperature (SAFT) by PSTC-17.

In one embodiment, the articles of manufacture of the invention can be coating compositions.

The compositions of the present invention may be prepared according to any suitable method, techniques and equipment. For example, the components of the composition may be blended in a mixer, an extruder, an aluminum can, and/or at the point of application, e.g. a head mixing system. In some cases, the components of the composition may be blended, optionally with a solvent, to form a mixture, which can then be cast onto a backing or other substrate and dried or cured or partially cured to form an article comprising the curable composition.

Furthermore, the composition may be shaped into a desired form, such as a tape or sheet, by an appropriate technique including casting, extrusion, or roll coating techniques (gravure, reverse roll, etc.). Alternatively, the composition may be applied to a substrate using conventional adhesive application equipment recognized in the art, e.g. curtain coating, slot-die coating, wire-wound rod coating, gravure coating, roll coating, knife coating, hot or “warm” melt coating. The composition may be applied as either a continuous or discontinuous coating or film or layer or sprayed through different nozzle and/or head configurations at different speeds using typical application equipment. The application may be followed by drying or heat treatment.

In another embodiment, the curable adhesive of the present invention is a laminating adhesive for flexible packaging.

After formulation, the curable adhesive can be applied to a substrate and subsequently laminated to another substrate. Suitable substrates include but are not limited to textile, fabric, mesh, film, poly(acrylonitrile butadiene styrene) (ABS), polypropylene (PP), glass-filled PP, talc-filled PP, impact-modified PP, polycarbonate (PC), PC-ABS, biaxially oriented polypropylene (BOPP), thermoplastic polyolefin (TPO) compounds, pigmented TPO compounds, filled TPO compounds, rubber-modified TPO compounds, paper, glass, plastic, metal, PVC (polyvinyl chloride), PET (polyethylene terephthalate), modified PET such as PETG (PET modified with 1,4-cyclohexanedimethanol) and PCTG, MylarTM plastic, aluminum, leather, synthetic leather, vinyl, nonwoven materials, foams, painted surfaces, printed surfaces, thermosets, thermoplastics, polymer films such as polyethylene, polypropylene, oriented polyethylene, oriented polypropylene; metallized plastic films; aluminum foil; wood; metals such as aluminum, steel or galvanized sheeting; glass; urethane elastomers; primed (painted) substrates, and laminates, blends or coated substrates comprising at least one of these materials. Any of these substrates may be untreated, corona treated, chemically treated, plasma treated, flame treated, rubber-modified, impact-modified, filled with e.g. talc or glass, pigmented with e.g. carbon black, chromium oxide or titanium oxide, or otherwise modified as known by those skilled in the art to provide improved properties to the substrate.

The curable adhesive can be coated onto a substrate using techniques known in the art, for example, by spraying, draw-down, roll-coating, brushing, nozzle dispensing, printing, etc. and subsequently laminated to another substrate manually or by a roll-to-roll laminating machine. The coating and laminating process may be done at room temperature or elevated temperatures.

In some embodiments, the curable compositions of the present invention can be characterized by lap shear testing: ASTM D3163-01(2014) Standard Test Method for Determining Strength of Adhesively Bonded Rigid Plastic Lap-Shear Joints in Shear by Tension Loading. Impact strength can also be measured by any method known in the art, for example, by pendulum or ball drop impact tests.

In some embodiments, the curable compositions of the present invention can be used in flexible packaging and characterized by tests such as DIN ISO 53357 Internal Adhesion, DIN ISO 55529 Sealed Seam Strength, DIN 53357 Bonding Adhesion, DIN 53504 Elongation at Tear and Tearing Tension, ASTM D1003 Transparency of film, ASTM D2578 Wetting Tension of Film Surface, ASTM F1249 Water Vapor Transmission Rate, and/or ASTM F2622 or D3985 Oxygen Transmission Rate

The inventive compositions can exhibit improved heat resistance and/or improved adhesion over time, particularly after heat aging, as evidenced by tests such as elevated temperature aging of the adhered articles comprising the inventive compositions, followed by lap shear testing, by fiber tear testing, by peel testing, by peel adhesion failure temperature (PAFT) testing, by shear adhesion failure temperature (SAFT) testing, and/or by shear hold power testing at elevated temperatures such as 40° C., 60° C., 70° C., 85° C., 95° C., 105° C., 120° C. The adhered articles comprising the compositions of the invention can also exhibit improved humidity resistance as evidenced, for example, by aging at 95 to 100% relative humidity at 40° C. for 24 to 144 hours followed by any of the above listed adhesion and cohesion tests at room temperature and/or at elevated temperature.

Improved chemical resistance of the compositions can be shown by reduced degradation of adhesive and cohesive strength after exposure to selected chemicals. In general, resistance to solvents, water, foods, cleaning products and other chemicals can be measured by direct exposure up to and including immersion for a period of time followed by adhesive and cohesive testing as described above to compare to pristine material testing. Visual observations are made in general for degradation of articles during/after exposure. Uptake of the test fluid can be measured gravimetrically or spectroscopically.

### EXAMPLES

### Example 1: Silane Resin Functionalization by Modification of Polar Linkers

In the following examples, various resins are functionalized with silane moieties as described below. The functionalized resins can be synthesized using the different methodologies provided hereinbelow, as well as other methodologies apparent to one of skill in the art upon reading the methods provided below. All chemical reagents were from Sigma-Aldrich (St. Louis, Mo., U.S.), unless otherwise noted.

### Example 1.1 - Synthesis of Pendant Silane-Containing Resin via Acetoxystyrene Functionalization

Steps 1A through 1C show the synthesis of pendant silane-containing resin by functionalization of acetoxystyrene. Particularly, Scheme 1 shows an embodiment of the ether route for deprotection of acetoxystyrene-based resin to phenol, followed by ether formation, and silane functionalization at an internal, pendant position within the resin. Note that in the following Schemes 1 through 5, where the variables “r” and “q” appear, the representation on the left is of the functionalization moiety, not the entire resin backbone. In other words, the starting materials represented in these schemes are representative of the many points at which the resin backbone is derivatized, the resin backbone not being present or depicted in the Schemes themselves, but are implied. The derivatization occurs randomly throughout the entire resin backbone. The starting material representations do not indicate a block copolymer, or that block copolymer methods were used in these strategies, though such strategies are known and can be employed in these Examples instead of the methodologies set forth below.

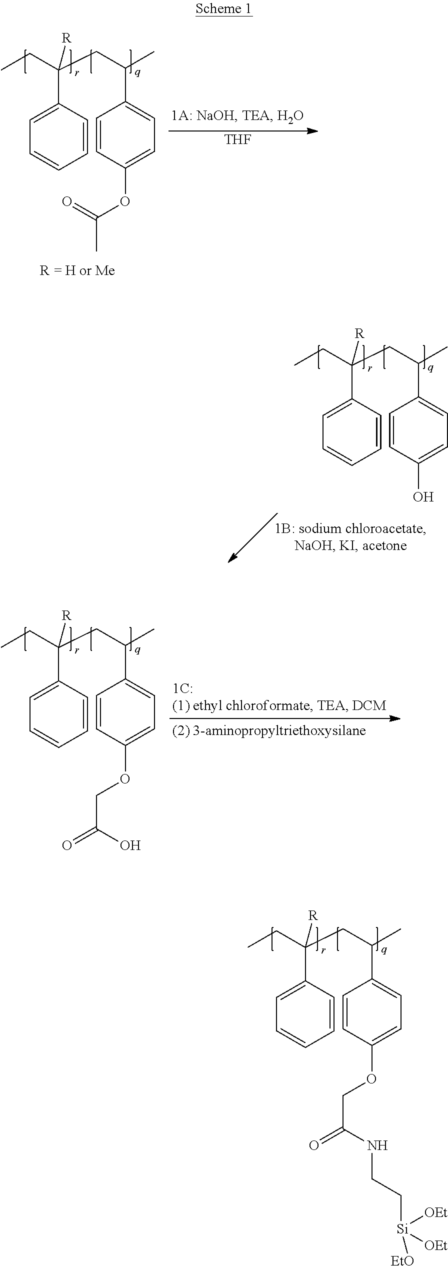

Step 1A: Synthesis of pendant phenol-functionalized resin from acetoxystyrene deprotection. To modify acetoxystyrene-containing resins in Step A, phenol deprotection of acetoxystyrene-modified resin was achieved by using base to remove the acetoxy groups. In a one-necked, 1 L round-bottom flask (RBF), a stir bar and 110.3 g of 3.4 mol % acetoxystyrene-containing resin (0.957 mol containing 0.0324 mol of acetoxystyrene units) were charged. Tetrahydrofuran (THF, 600 mL) was added. The solution was stirred at 500 rpm. A solution of 3.9 g of sodium hydroxide (0.0975 mol) was prepared in 20.4 mL of deionized water. When the starting material resin fully dissolved, the solution of sodium hydroxide was added. Triethylamine (TEA, 16.4 g, 0.162 mol) was added, and the RBF was fitted with a condenser. The solution was heated to reflux for 4 to 5 hours. The reaction was monitored by FT-IR. The reaction was considered complete when the carbonyl band (1750 cm⁻¹) fully disappeared. Heating was stopped. The flask was allowed to cool to room temperature. THF was evaporated. Dichloromethane (DCM, 600 mL) was added to the RBF, and the solution was stirred vigorously. The solution was then transferred into a separatory funnel. The organic layer was washed with 2×600 mL of aqueous HCl (1 mol/L) and then 4×600 mL of deionized water. The organic layer was dried over magnesium sulfate. The solid was filtered, and the filtrate was kept. The DCM was evaporated, and the product was dried at 40° C. under reduced pressure until constant weight. The final yield was 102.2 g (94% of the theoretical yield).

Step 1B: Synthesis of pendant carboxylic acid-functionalized resin from phenol group functionalization. In a 1-necked, 2 L round-bottom flask, 95.2 g of 3.38 mol % phenol-functionalized resin (836.5 mmol containing 28.3 mmol of phenol units) and 839 mL of acetone were charged. The mixture was stirred until the resin fully dissolved. Then, 4.58 g of potassium iodide (27.6 mmol), 2.27 g of sodium hydroxide (56.8 mmol), and 16.7 g of sodium chloroacetate (143.4 mmol) were added. The flask was fitted with a reflux condenser and heated with an oil bath to 58° C. for 18 hours. The solvent was removed. The viscous material was dissolved in 700 mL of DCM. The obtained slurry was added to 700 mL of aqueous HCl 1 M solution. The two-phase system was stirred until complete dissolution of the solid materials, and the aqueous layer was discarded. The organic phase was washed with aqueous HCl 1 M solution, followed by aq NaOH 1 M solution, and then washed a last time with aqueous HCl 1 M solution. The procedure was repeated, and the aqueous layer was discarded each time. Then, the organic phase was washed an additional 4 times as needed with aqueous HCl 1 M solution. The organic layer was separated and dried over anhydrous MgSO₄. MgSO₄ was removed by gravimetric filtration over filter paper, and the filtrate was kept. Solvent was removed, and the product was dried under reduced pressure at room temperature overnight. The obtained solid weighed 86.7 g (90% of the theoretical yield).

Step 1C: Synthesis of pendant silane-functionalized resin from carboxylic acid group functionalization. In a 3-necked, 2 L round-bottom flask fitted with a thermometer and a stir bar, 83.0 g of 3.38 mol % carboxylic acid containing resin (717 mmol containing 24.2 mmol of carboxyl units) and 715 mL of DCM were charged. The solution was placed under a N₂ blanket and magnetically stirred. When the resin was fully dissolved, the flask was chilled with an ice/NaCl/water bath. When the temperature reached 2.5±2.5° C., 2.69 g of ethyl chloroformate (24.8 mmol) followed by 2.46 g of TEA (24.3 mmol) were added. The activation time (formation of mixed anhydride) was 30 min at 5±3° C. Then, 5.38 g of 3-aminopropyltriethoxysilane (24.3 mmol) was charged. The chilling bath was removed, and the solution was allowed to warm to room temperature and continue reaction for 23 hours. The reaction solution was dried over anhydrous MgSO₄. The solid was removed by gravimetric filtration over Whatman® #1 filter paper. The solvent was removed, and 50 mL of anhydrous reagent alcohol was added to the flask. The solvent was decanted, and the waxy product was washed one more time with 50 mL of anhydrous reagent alcohol. The product was dried under reduced pressure at room temperature for over 48 hours. The product weighed 81.0 g (92% of the theoretical yield). Silica incorporation was confirmed as 5500 parts per million (ppm) using a xylenes inductively-coupled plasma (ICP) digestion method.

### Example 1.2: Synthesis of End-Capped Silane-Containing Resin via Phenol Functionalization

Scheme 2 shows a similar embodiment of the ether route for deprotection of acetoxystyrene-based resin to phenol, followed by ether formation, and silane functionalization, but instead of the functionalization occurring at an internal, pendant position within the resin, the silane functionalization is added to the end cap, terminal, position of the resin. In this embodiment, the phenol groups were functionalized with carboxylic acid groups via reaction of phenol, sodium hydroxide, sodium chloroacetate, and potassium iodide catalyst.

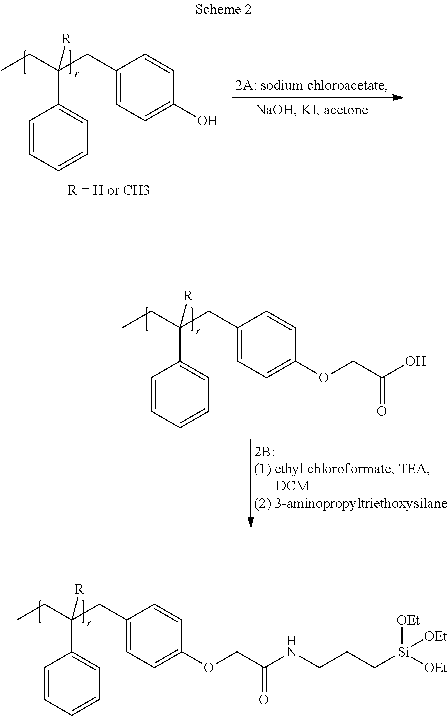

Step 2A: Synthesis of end-capped COOH-functionalized resin from phenol group functionalization. In a 3-necked, 2 L round-bottom flask fitted with a mechanical stirrer and reflux condenser, 100.6 g of 10.8 mol % phenol-functionalized resin (902 mmol containing 97.2 mmol of phenol units) and 1.50 L of acetone were charged. When the resin was fully dissolved with stirring, 10.55 g of potassium iodide, 6.48 g of sodium hydroxide, and 101.1 g of sodium chloroacetate were added. The reaction solution was heated to 57° C. for 18 hours. Solvent was removed, and the product was dissolved in 3 L of DCM and washed with 1.2 L of 1 M aqueous HCl. The two-phase solution was stirred until complete dissolution of all solids. The aqueous layer was discarded. The solution was washed with 1 M aqueous HCl, 1 M aqueous NaOH, and then 1 M aqueous HCl The procedure was repeated and washed with 1 M aqueous HCl four more times as needed. The organic phase was dried over anhydrous MgSO₄. MgSO₄ was removed by gravimetric filtration over filter paper. Solvent was removed, and the product was dried in under reduced pressure at room temperature overnight. The product weighed 103.8 g (98% of the theoretical yield).

Step 2B: Synthesis of end-capped silane-functionalized resin from COOH group functionalization. In a 3-necked, 3 L round-bottom flask fitted with a thermometer and a stir bar, 106.0 g of 10.8 mol % carboxylic acid containing resin (900 mmol containing 97.0 mmol of carboxyl units), and 2.70 L of DCM were charged. The solution was placed under a N₂ blanket and magnetically stirred. When the resin was fully dissolved, the flask was chilled with an ice/NaCl/water bath. When the temperature reached 2.5±2.5° C., 10.75 g of ethyl chloroformate (99.1 mmol) followed by 9.97 g of TEA (98.5 mmol) were added. The activation time (formation of mixed anhydride) was 32 min at 5±3° C. Then, 21.58 g of 3-aminopropyltriethoxysilane (97.5 mmol) was charged. The chilling bath was removed, and the reaction was allowed to warm to room temperature. The reaction was allowed to continue 25 hours at room temperature. Insoluble (triethylamine hydrochloride) was removed by gravimetric filtration over Whatman® #1 filter paper. Then, 300 mL of hexanes was added. The mixture was stirred for 30 minutes and stored in the freezer for 48 hours. The two-phase system was allowed to warm to room temperature. The top hexanes layer was isolated, and solvent was removed. The product was dried under reduced pressure at room temperature for 2 to 3 days. Dry ethanol was used to help remove hexanes. The waxy product weighed about 80 g (63-64% of the theoretical yield). An alternative workup is to remove all solvent under reduced pressure after the reaction is complete and dissolve the product in diethyl ether or methyl tertiary butyl ether (MTBE). The solution is then filtered over filter paper to remove triethylamine hydrochloride byproduct, and the solvent is slowly evaporated. The product is dried at room temperature under reduced pressure. ICP Si product content was 19820 ppm. ¹³C and ²⁹Si nuclear magnetic resonance (NMR) confirmed 6.4 to 6.8 mol % silane functionalization.

### Example 1.3: Synthesis of Pendant Silane-Containing Resin via Phenol Functionalization with Anhydride Silane

The following is an example of the synthesis of a silane-containing/ester modified resin using an acetoxystyrene-modified starting material, as depicted in Scheme 3. In this embodiment, phenol groups of resins were formed by hydrolysis of acetoxy functions, then reacted with 3-(triethoxysilyl)propylsuccinic anhydride to provide the formation of ester linkage to form a functionalized resin having the Formula: resin-OCO—CH(CH₂COOH)((CH₂)₃—Si(O CH₂CH₃)₃).

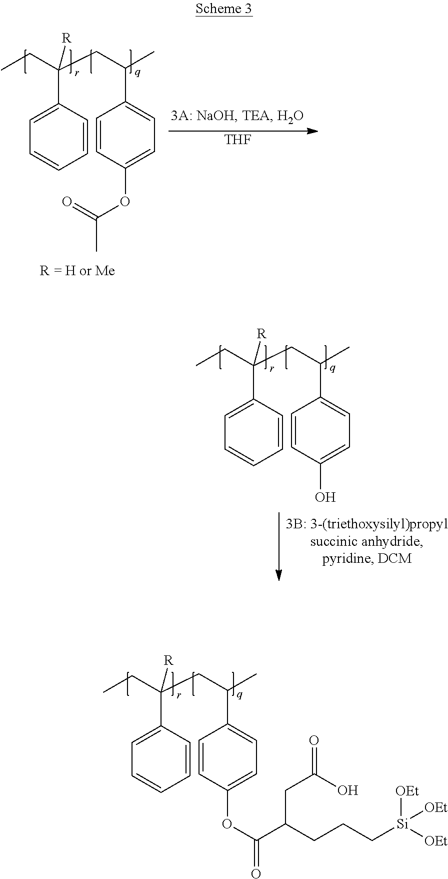

Step 3A: Synthesis of pendant phenol-functionalized resin from acetoxystyrene deprotection. In a one-necked, round-bottom flask (RBF), a stir bar and 50.0 g of 3.4 mol % acetoxystyrene-containing resin were charged. Tetrahydrofuran (279 mL) was added. The solution was stirred. A solution of 1.76 g of sodium hydroxide was prepared in 9.25 mL of deionized water. When the starting material resin fully dissolved, the solution of sodium hydroxide was added. Triethylamine (TEA, 7.43 g) was added, and the RBF was fitted with a condenser. The solution was heated to reflux for 4 hours. The reaction was monitored by FT-IR. The reaction was considered complete when the carbonyl band (1750 cm-1) fully disappeared. Heating was stopped. The flask was allowed to cool to room temperature. THF was evaporated. Dichloromethane (DCM, 280 mL) was added to the RBF, and the solution was stirred vigorously. The solution was then transferred into a separatory funnel. The organic layer was washed with 2×280 mL of aqueous HCl (1 mol/L) and then 4×280 mL of DI water. The organic layer was dried over magnesium sulfate. The solid was filtered, and the filtrate was kept. The DCM was removed, and the solid product was dried at 30° C. under reduced pressure until constant weight.

Step 3B: Synthesis of pendant silane-functionalized resin from phenol modification with anhydride silane. In a 100 mL one-necked round bottom flask, a stir bar and 5.00 g of 3.4 mol % hydroxystyrene-containing resin (0.0423 mol containing 0.0015 mol of hydroxystyrene units) were charged. DCM (42 mL, 0.04 mol/L in hydroxystyrene units) was added. When the reaction solution was transparent, the solution was flushed with nitrogen. The flask was fitted with a reflux condenser, and 0.150 g of anhydrous pyridine (0.0019 mol) was added followed by 0.907 g of 3-(triethoxysilyl)propyl succinic anhydride (0.0030 mol). The reaction continued at 38 to 40° C. for about 46 hours. DCM was removed under reduced pressure. The product was washed with 50 mL of anhydrous ethanol (twice) and dried under reduced pressure at 30° C. until constant weight. The yield was 2.6 g (48% of the theoretical yield).

### Example 1.4: Synthesis of Pendant Silane-Containing Resin via Succinic Anhydride Grafting onto Kristalex™ 3085

In this embodiment, styrene or poly(alpha-methyl)styrene (AMS) resins were reacted with anhydrides, such as succinic anhydride, to create a carboxylic acid moiety onto which the silane moiety is added, as depicted in Scheme 4.

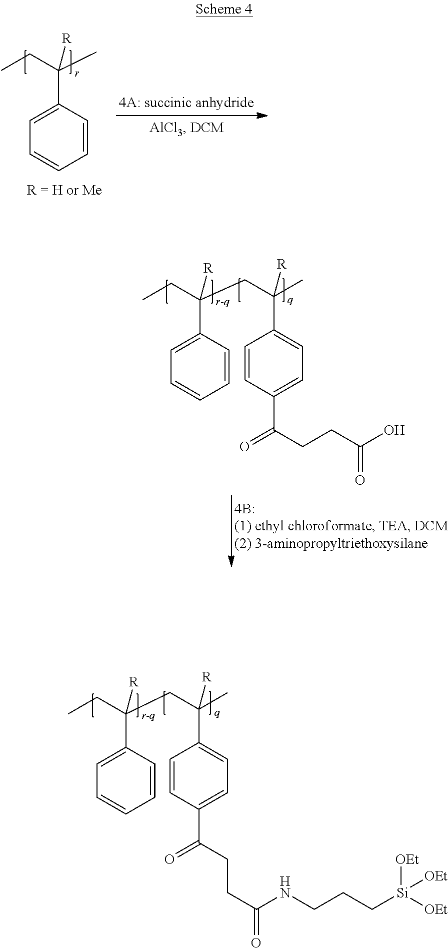

Step 4A: Synthesis of pendant COOH-functionalized resin from grafting succinic anhydride onto Kristalex™ 3085. A 3-necked, 2 L round-bottom, 2 L flask was fitted with a thermometer, a pressure-equalized addition funnel, and a magnetic stirrer and placed under N₂. Then, 77.5 g of anhydrous AlCl₃ (581.2 mmol) was made into a slurry with 260 mL of DCM and charged into the bottom of the round-bottom flask with stirring. A separate 1 L round-bottom flask was charged with 100.0 g of Kristalex 3085 (880.4 mmol), 800 mL of DCM, and 26.4 g of succinic anhydride (263.8 mmol) under nitrogen and magnetically stirred until complete dissolution of the solids. The solution was transferred into the pressure-equalized addition funnel for dropwise addition. The solution of AlCl₃ and DCM was chilled with an ice/NaCl/water bath. The temperature of the reaction mixture was maintained between −3 and 5° C. during the slow addition of resin/anhydride solution (over 160 min). The reaction was allowed to continue for 3 hours after the addition was completed, maintaining the temperature at 0-15° C. Then, 600 mL of aq HCl 2.5 M solution was cautiously added. The two-phase system was stirred at room temperature overnight. The aqueous phase was discarded. DCM was added to the organic phase to reach a total volume of 1.8 L. The obtained solution was divided into two equal portions. Each portion was washed with aqueous HCl 1 M (6 times), then with aqueous NaCl 200 g/L (once). The two portions were combined and dried over anhydrous MgSO₄. The solid was removed by filtration over a filter paper. The solvent was removed, and the product was dried under reduced pressure at room temperature for about 20 hours. The yellowish solid weighed 90.2 g (71% of the theoretical yield). Acid titration data is provided below in Table 2.

TABLE 2
Acid Titration of Step 4A Product

| Trial | sample weight | ml [OH] | Acid # (mg KOH/g) | wt % total acid |
|---|---|---|---|---|
| 1 | 0.0476 | 10.2 | 114.34 | 35.94 |
| 2 | 0.0444 | 10 | 120.06 | 37.72 |

Average = 117.20 mg KOH/g
Average = 2.09 mmol acid/g

Step 4B: Synthesis of pendant silane-functionalized resin from COOH group functionalization. A 3-necked, 1 L round-bottom flask was fitted with a thermometer and charged with 72.9 g of 27.87 mol %-Carboxyl-Kristalex™-3085 (515.3 mmol containing 143.6 mmol of carboxyl units) and 450 mL of DCM with magnetic stirring under nitrogen. When the resin was fully dissolved, the round-bottom flask was chilled with an ice/NaCl/water bath. When the temperature reached 2.5±2.5° C., 15.6 g of ethyl chloroformate (143.8 mmol) followed by 14.6 g of TEA (144.3 mmol) were added. The activation time (formation of mixed anhydride) was 12 min at 5±3° C. Then, 30.3 g of 3-aminopropyltriethoxysilane (136.9 mmol) was charged. The chilling bath was removed, and the reaction was allowed to warm to room temperature. The reaction time was about 15 hours at room temperature. Solvent was removed, and the product was dried under reduced pressure at room temperature overnight. Then, 500 mL of anhydrous diethyl ether was added under nitrogen. The mixture was magnetically stirred until complete dissolution of the resin versus the insoluble byproduct (triethylamine hydrochloride). The byproduct was removed by gravimetric filtration over Whatman® #1 filter paper. Dry N₂ was bubbled through the filtrate to evaporate most of the ether. The product was dried under reduced pressure at room temperature overnight. The waxy product weighed 92.2 g (90% of the theoretical yield). ICP measured value for Si was 35700 ppm. ²⁹Si and ¹³C NMR images indicated 13 to 21 mol % functionalization.

### Example 1.5: Synthesis of Pendant Silane-Containing Resin via Free Radical Copolymerization

In this embodiment, the synthesis of functionalized resin proceeds from an earlier starting point, where the resin polymer monomers are reacted with silane moieties directly to form functionalized resin in one step, as depicted in Scheme 5.

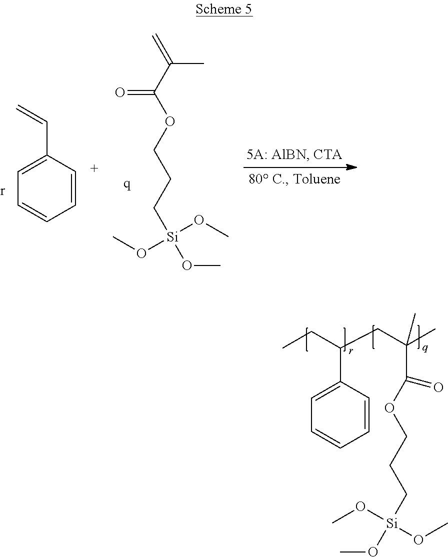

Step 5A: Synthesis of pendant silane-functionalized resin from free radical copolymerization with methacrylate silane. To a 500 mL three-necked round-bottom flask equipped with an overhead paddle-blade stirrer, thermocouple probe, water-cooled reflux condenser, and 250 mL addition funnel was charged 200 mL reagent-grade toluene, 2 g vinylsilane, 160 g styrene and 60 g 2,4-diphenyl-4-methyl-1-pentene (Sigma-Aldrich, St. Louis, Mo., U.S.) as the chain transfer agent (CTA) and the charge stirred for 20 minutes. To this mixture was then added 40 g 3-(trimethoxysilyl) propylmethacrylate (CAS #2530-85-0) and the entire mixture heated to 80° C. while applying a slow nitrogen sparge to preserve an inert atmosphere.

To the addition funnel was charged a solution of 4 g azobisisobutyronitrile (AIBN) dissolved in 100 mL 50/50 ethyl acetate/toluene and then added over about 4 hours to the reaction mixture while maintaining the nitrogen sparge and the reaction temperature of 80° C. This condition was held for a further 4 hours before the mixture was allowed to cool and the reactor contents discharged to a wiped-film evaporator apparatus. Solvent, CTA, and any unreacted monomers were then removed under reduced pressure of about 2 torr at a temperature of up to about 200° C. The product was a sticky solid containing some residual CTA and having a molecular weight (gas-phase chromatography (GPC), right, polystyrene standards, of 900 (Mₙ), 3,530 (M_{w}), and 7,140 (Mz).

The nuclear magnetic resonance spectrum was generally consistent with a polystyrene structure and exhibited a strong broad peak at about 3.55 ppm for the (trimethoxy)silyl moiety whose integrated area was also consistent with the amount charged, indicting essentially complete incorporation of the silicon-bearing monomer into the polymer chain.

### Example 1.6: Synthesis of End-Capped Silane-Containing Resin via Phenol Functionalization through Succinic Anhydride

In this embodiment, the synthesis of functionalized resin proceeds by phenol functionalization using succinic anhydride to form an end-capped derivative, as depicted in Scheme 6.

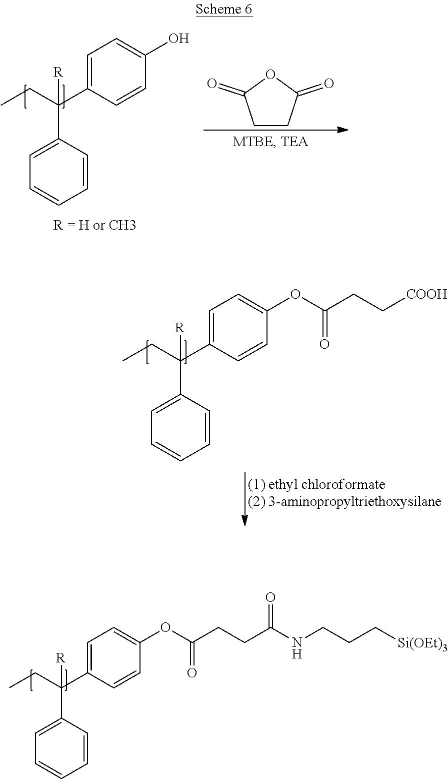

To a 1L round bottom flask fitted with a stir-bar and a reflux condenser were charged phenol-functionalized resin (56.7 g; containing 38.4 mmol of phenol unit), anhydrous MTBE (380 mL), and triethylamine (5.4 mL; 38.74 mmol). The mixture was stirred under N₂ blanket. When the resin was fully dissolved, succinic anhydride (3.85 g; 38.47 mmol) was added at once. The flask was heated to 57° C. (oil bath) for 17 hours, then room temperature for one half hour. The mixture was then chilled with an ice-water-NaCl bath. Ethyl chloroformate (3.7 mL; 38.7 mmol) was added over 4 min. The activation time was 30 min. 3-Aminopropyltriethoxysilane (9.0 mL; 38.5 mmol) was charged and the chilling bath was removed. The reaction time (amide formation) was 6 hours at room temperature. The solid by-product was removed by filtration. The volatiles were stripped under reduced pressure and the residue was dried under vacuum at room temperature for 3 days. The resulting white powder product weighed 58.2 g (85% of the theoretical).

### Example 1.7: Synthesis of End-Capped Silane-Containing Resin via Phenol Functionalization with Chloro-Silane

In this embodiment, the synthesis of functionalized resin proceeds in this embodiment by (3-chloropropy)triethoxysilane reaction with sodium ethoxide, sodium iodide, and acetone to yield the end-capped silane derivative, as depicted in Scheme 7.

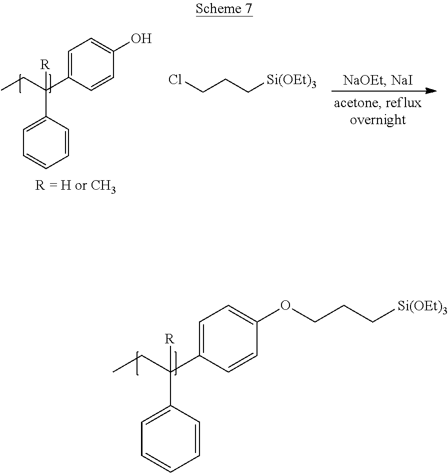

In a 3-neck round bottom flask fitted with a thermometer, overhead stirrer, and nitrogen atmosphere were charged 3 g phenol-functionalized resin (0.677 mmol phenol per 1 gram of resin) and 6 mL acetone (dried over magnesium sulfate). The reaction mixture was placed under a nitrogen blanket and agitated with a mechanical overhead stirrer. The reaction mixture was heated to 20 to 25° C. to dissolve the resin. After dissolving the resin in acetone, sodium ethoxide (0.191 g) was added to the reaction mixture and stirred for 15 minutes. Subsequently sodium iodide (0.42 g) was added at 45 to 50° C. Then (3-chloropropy)triethoxysilane (0.848 g) was added and the reaction temperature adjusted to 55° C. The reaction mixture was stirred for 24 hours at 55° C. After 24 hours reaction time, n-heptane was added to the reaction mixture to precipitate salts. The salts were removed via filtration on a Buchner funnel by filtering through a Celite pad. The reaction mixture was stripped using a Rotary evaporator. The amorphous product weighed 3.1 g (88% of theory).

### Example 1.8: Synthesis of Pendant Silane-Containing Resin via Copolymerization of Isobornylmethacrylate and 3-(Trimethoxysilyl)propylmethacrylate

In this embodiment, the synthesis of pendant functionalized resin in this embodiment is achieved by reaction of isobornylmethacrylate with 3-(trimethoxysilyl) propylmethacrylate under the conditions set forth in Scheme 8.

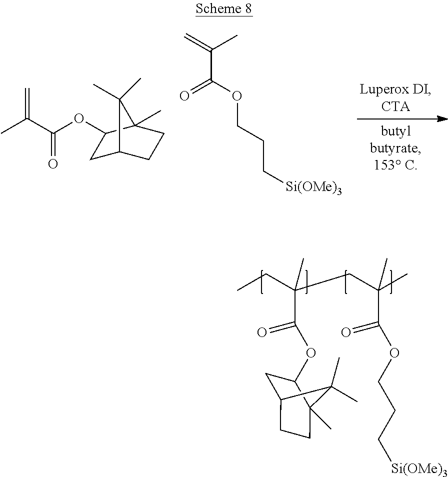

A 1 L 3-necked round-bottom flask equipped with nitrogen inlet, overhead stirrer, thermocouple probe, reflux condenser, and port fitted with a 500 mL addition funnel was charged with 250 mL butylbutyrate process solvent. The addition funnel was charged with a solution of 16 g Luperox DI (di-tert-butylperoxide, 8 wt % on total monomers), 40 g 3-(trimethoxysilyl)propylmethacrylate (20 wt % or 18.3% molar on total monomers), 160 g isobornylmethacrylate, and 50 mL butylbutyrate. The reactor was heated under a gentle stream of nitrogen with agitation to 153° C. and held at this temperature for the course of the reaction. The monomers and initiator solution was then added slowly, dropwise, to the reactor, over 2 hours. After addition was completed, the reaction mixture was held at 153° C. an additional 3 hours then cooled to room temperature under a continued gentle stream of nitrogen. Product polymer is obtained by stripping the solvent under vacuum up to about 200° C. Appearance: Slightly hazy, water-white amorphous solid.

### Example 1.9: Synthesis of End-Capped Silane-Containing Resin via Phenol Functionalization with Glycidoxy Silane

In this embodiment, the synthesis of end-capped functionalized resin is achieved by PPh₃ reaction with glycidoxypropyltriethoxysilane, as depicted in Scheme 9.

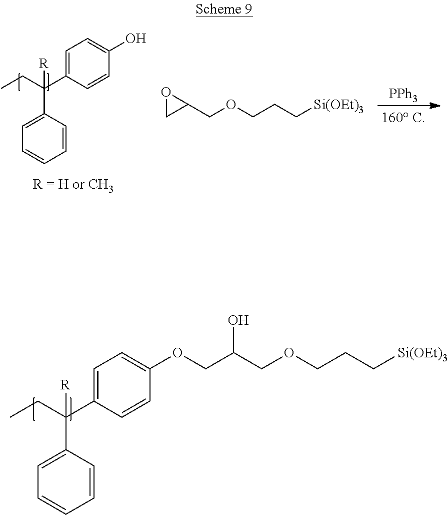

To a 3-neck, 500 mL round bottom flask equipped with a magnetic stir bar and a reflux condenser with N₂ gas overflow was charged 150 g of phenol-functionalized resin (0.677 mmol phenol per 1 gram of resin). The resin was heated to 160° C. using a silicon oil bath. Then 1.5 g triphenylphosphine was added to the flask. After complete dissolution, 27.5 g of 3-glycidoxypropyltriethoxysilane was added to the flask using a syringe. The reaction mixture was then stirred for 6 hours at 160° C. The reaction mixture was thereafter cooled to room temperature. The crude product was dissolved in methyl ethyl ketone and then precipitated into methanol. The precipitated solid was collected and then dried under reduced pressure with N₂ purge at 80° C.

By using the same method as described in Example 1.9, the silane functionalized resin below was also prepared:

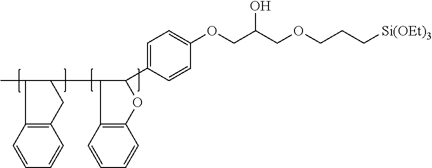

### Example 1.10: Synthesis of End-Capped Silane-Containing Resin via Acid Functionalization with Glycidoxy Silane

In this embodiment, the synthesis of end-capped functionalized resin proceeded by use of an acid-functionalized hydrocarbon resin incubated with 3-glycidoxypropyl-triethoxysilane, as depicted in Scheme 10.

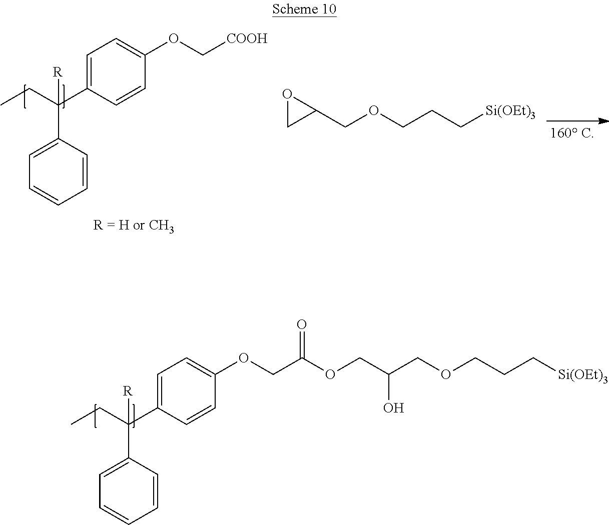

To a 100 mL round bottom flask was charged 10 g of an acid-functionalized hydrocarbon resin (0.31 mmol of acid function per one gram of resin). The resin was heated to 160° C. in an oil bath with magnetic stirring under N₂ gas. To this was added 1.84 g of 3-glycidoxypropyltriethoxysilane in one portion. This mixture was then stirred at 160° C. under nitrogen for six hours before it was cooled down to room temperature to afford the described product. The crude product was dissolved in methyl ethyl ketone and then precipitated into methanol. The precipitated solid was collected and then dried under reduced pressure with N₂ purge at 80° C.

### Example 1.11: Synthesis of End-Capped Silane-Containing Resin via Phenol Functionalization with Glycidoxy Silane

In this embodiment, the synthesis of end-capped functionalized resin was achieved by incubation of 3-glycidoxypropyltriethoxysilane and acid-modified resin with triphenylphosphine, as depicted in Scheme 11.

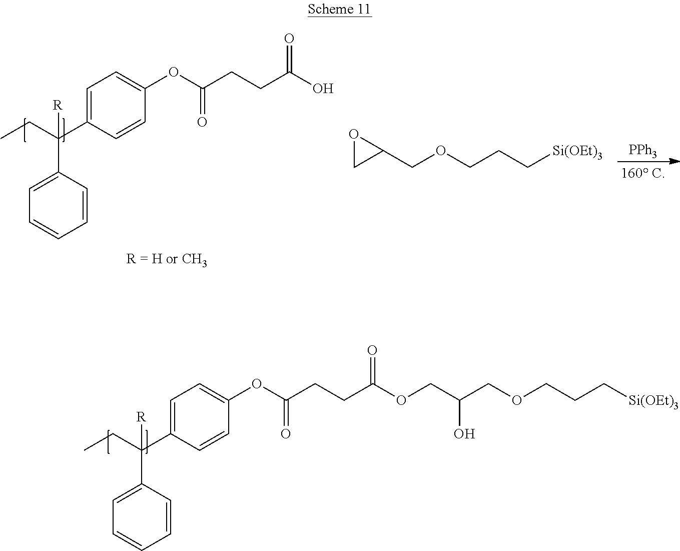

Into a 3-neck, 500 mL round bottom flask equipped with a magnetic stir bar, reflux condenser, and septum was added 60 grams of an acid modified resin (acid number 53 mg KOH/g) under an N₂ blanket. The resin then was heated to 180° C. after which 0.3 g triphenylphosphine was added to the flask. Upon complete dissolution, 15.76 g of 3-glycidoxypropyltriethoxysilane was added to the flask in one portion. This mixture was then stirred at 180° C. under nitrogen for six hours before it was cooled down to room temperature. The crude product was dissolved in methyl ethyl ketone then precipitated into methanol. The precipitated solid was collected then dried under reduced pressure with N₂ purge at 80° C.

### Example 1.12: Synthesis of End-Capped Silane-Containing Resin via Phenol Functionalization with Phthalic Anhydride and Glycidoxy Silane

In this embodiment, the synthesis of functionalized resin is performed by incubation of the functionalization unit with phthalic anhydride and 3-glycidoxypropyltriethoxysilane to create an end-capped functionalized resin, as depicted in Scheme 12.

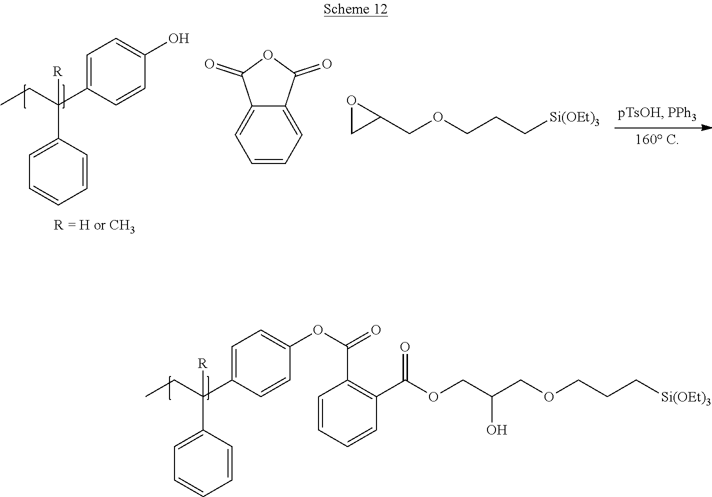

To a 100 mL round bottom flask equipped with a magnetic stir bar was charged 10 g of phenol-functionalized resin (0.677 mmol phenol per 1 gram of resin). The resin was heated to 160° C. using a silicon oil bath. P-toluenesulfonic acid, 0.074 g, was then added to the flask. After 15 min, 0.98 g phthalic anhydride was added to the flask. The mixture was stirred for 2 hours at 160° C. followed by addition of 0.1 g triphenylphosphine and 1.84 g 3-glycidoxypropyltriethoxysilane. The mixture was then stirred for an additional 4 hours before it was cooled to room temperature. The crude product was dissolved in methyl ethyl ketone and then precipitated into methanol. The precipitated solid was collected and then dried under reduced pressure with N₂ purge at 80° C.

The above methods described in Examples 1.1 to 1.12 yield various functionalized resin compositions obtained through different routes of synthesis. Each route can be varied according to known procedures to yield resins possessing different properties, i.e. different degrees of functionalization, different molecular weights, different Tg values, etc. While many hundreds of such samples were made, provided in Table 3 are chemical and physical properties of several examples of silane resins functionalized by modification of polar linkers synthesized as described the above in Examples 1.1 to 1.5.

TABLE 3
Exemplary Properties of Functionalized Resins

| | | | | | | | Silane | Silane | Silane | |
|---|---|---|---|---|---|---|---|---|---|---|
| | | | | | | Measured | via ¹³C | via ¹³C | via ¹³C | Silane |
| | | | | | | Si via ICP | NMR | NMR | NMR | via ²⁹Si |
| Sample | | | | | | or XRF | Si—CH₂— | amide | —Si—(O—CH₂—CH₃)₃ | NMR |
| Type | Mₙ | M_{w} | M_{z} | PDI | T_{g} | (ppm) | (mol %) | (mol %) | (mol %) | (mol %) |
| 1 | 688 | 5499 | 24523 | 5.45 | 16 | 273 | — | — | — | — |
| 1 | 740 | 1209 | 2316 | 1.63 | 36 | 5500 | — | — | — | — |
| 2 | 629 | 787 | 1083 | 1.25 | 34 | 9590* | — | — | — | — |
| 2 | 642 | 772 | 927 | 1.20 | −5 | 19820 | — | 6.8 | 6.4 | 6.7 |
| 2 | 688 | 902 | 1706 | 1.31 | −5 | 26500 | — | 5.7 | 7.2 | 6.6 |
| 3 | 647 | 888 | 1541 | 1.37 | 28 | 394 | — | — | — | — |
| 4 | 534 | 1133 | 2439 | 2.12 | −7 | 16200 | 7.7 | 5.9 | 6.4 | 6.4 |
| 4 | 733 | 1452 | 2699 | 1.98 | −13 | 29000 | 18 | 19 | 12 | 12 |
| 4 | 816 | 2019 | 5282 | 2.47 | −7 | 35700 | 21 | 27 | 15 | 13 |
| 2 | 932 | 2065 | 3988 | 2.22 | 32 | 8440 | 1.4 | — | 1.7 | 1.5 |
| 2 | 920 | 2064 | 4009 | 2.24 | 30 | 5910 | 4.4 | 2.7 | 4.5 | 4.0 |
| 6 | 761 | 1086 | 1822 | 1.43 | 25 | 9550 | — | — | — | — |
| 7 | 698 | 967 | 1624 | 1.39 | | 30400 | — | — | — | — |
| 8 | 900 | 1280 | 2220 | 1.42 | 8 | 15900 | — | — | — | 1.87 |
| 9 | 743 | 1168 | 2262 | 1.57 | 21 | 10500 | — | — | — | — |
| 10 | 862 | 1905 | 4635 | 2.21 | | 11000 | — | — | — | — |
| 11 | 979 | 1809 | 4903 | 1.85 | 16 | 14200 | — | — | — | — |
| 12 | 695 | 1234 | 3190 | 1.78 | | 12700 | — | — | — | — |

*X-Ray Fluorescence (XRF) determined value; all other values determined by ICP
Sample Type:
1 = acetoxy pendant route
2 = phenol end-capped route
3 = silane anhydride grafting route
4 = succinic anhydride grafting route
5 = one pot methacrylate silane copolymerization route
6 = end-capped ester amide route
7 = end-capped phenyl ether route
8 = copolymer of isobornylmethacrylate and 3-(trimethoxysilyl)propylmethacrylate
9 = glycerol ether route
10 = glycerol ester route
11 = glycerol succinate route
12 = glycerol ester ether route

### Example 2: Analytical Characterization of Functionalized Resins, General Methods

General methods: Analytical analysis was completed on each silane-functionalized resin product. IR was used to monitor the reactions. NMR or ICP was used to confirm the presence of silane. Differential scanning calorimetry (DSC) and thermogravimetric analysis (TGA) were used to evaluate thermal stability. GPC was used to determine any molecular weight changes.

Fourier transform—infrared spectroscopy (FT-IR) was conducted using a PerkinElmer® spectrometer with a resolution derived from 8 scans (PerkinElmer, Waltham, Mass., U.S.). The samples were prepared by dissolving about 10 mg of material in 0.1 mL of DCM. One to two drops of the obtained solution were placed on an KBr card and dried under N₂ flow for a few min.

Generally, ²⁹Si and ¹³C NMR analysis involved dissolving resin (100-300 mg, depending on sample availability) and chromium(III) acetylacetonate (16 to 36 mg) in 1 mL of deuterated chloroform. The samples were stirred at ambient temperature until all materials were fully dissolved. Hexamethyldisiloxane (40 to 100 microliters) was added to each solution as an internal standard, and the samples were stirred again briefly. The sample solutions were then transferred to 5 mm NMR tubes. Spectra were acquired at 26° C. at 125 or 150 MHz for carbon NMR and 99 or 119 MHz for silicon NMR. The relaxation delay was 1 to 2 seconds for carbon NMR and 5 seconds for silicon NMR. The number of scans was typically 12500 for carbon NMR and 1250 for silicon NMR up to 24000 for carbon NMR and 7400 for silicon NMR. Calculations of the functionality level were completed using both silicon NMR and carbon NMR. NMR was run on a Bruker 500 MHz Avance II NMR spectrometer (Bruker Corp., Billerica, Mass., U.S.), with a ¹H frequency of 500 MHz, a ¹³C frequency of 125 MHz, and a ²⁹Si frequency of 99 MHz. An Agilent 600 MHz DD2 spectrometer with a ¹H frequency of 600 MHz, a ¹³C frequency of 150 MHz, and a ²⁹Si frequency of 119 MHz also was used for some samples (Agilent Technologies, Inc., Santa Clara, Calif., U.S.). All samples were run at 26±1° C. unless specified.

A standard procedure for ICP included preparation of samples either using a digestion method or an alternative preparation in xylenes or a suitable solvent selected for the sample. For digestion, approximately 250 milligrams of sample was weighed into a clean Teflon sample tube. Then, 3 mL of concentrated nitric acid was added to each tube (Trace metal grade, Fisher Chemical, Whippany, N.J., U.S.). The sample tubes were then capped and placed in the microwave. Samples were microwave-digested using a Ultrawave Single Reaction Chamber Digestion System (Milestone, Inc., Shelton, Conn., U.S., Table 4). Digestion procedure for microwave is listed below in Table 3. Digested samples were diluted to a volume of 25 mL, yielding a final acid concentration of ˜10% HNO₃ (based on nitric acid added and expected consumption of nitric acid during the digestion). A 1 ppm scandium internal standard was added to each sample. Each sample including the method blanks were then analyzed on a PerkinElmer® Optima 2100 ICP—optical emission spectrometry (OES) instrument (PerkinElmer, Inc., Waltham, Mass.) with a cyclonic unbaffled spray chamber and concentric nebulizer. The ICP-OES was calibrated with a matrix matched prepared 1 ppm calibration standard and blank. ICP-OES conditions are provided in Table 5.

TABLE 4
UltraWAVE Sample Preparation Conditions

| Action | Temperature (° C.) | Time (min) |
|---|---|---|
| Ramp | 130 | 15 |
| Hold | 130 | 5 |
| Ramp | 240 | 20 |
| Hold | 240 | 20 |

TABLE 5
ICP Instrument Conditions

| | |
|---|---|
| ICP RF Power (Watts) | 1500 |
| Plasma Ar Gas Flow (L/min) | 18 |
| Auxiliary Ar Gas Flow (L/min) | 0.2 |
| Nebulizer Gas Flow (L/min) | 0.6 |
| Pump Flow rate mL/Min | 1.25 |

DSC scans were performed under nitrogen on a TA Instruments Q200 or Q2000 Differential Scanning calorimeter (DSC, TA Instruments, New Castle, DE, US) equipped with a refrigerated cooling system (RCS-90) both using a heating rate of 20° C/min. Glass transition temperatures (Tg) were calculated and reported from the second heating traces. TGA was conducted under nitrogen with a TA Instruments Q500 Thermogravimetric Analyzer (TA Instruments, New Castle, Del, U.S.) at heating rate of 10° C/min with a nitrogen purge of 50 cc/min.

GPC methodologies were as follows: an Agilent 1100 HPLC (Agilent Technologies, Inc., Santa Clara, Calif., U.S.) equipped with refractive index detector (RID) was used for the GPC analysis. The sample was prepared by dissolving 25 mg of material in 10 mL of THF and sonicated for about 5 min. Then, 10 μL of toluene was added and swirled. A portion of this solution was added to a vial. Run Method: Flow: 1 mL/min, Solvent: THF, Runtime: 26 min, RID Temp: 30° C., Column Temp: 30° C., Injection: 50 μL, Calibration Material: EasiCal PS-1 (Agilent Technologies, Inc., Santa Clara, Calif., U.S., Part Number 2010-0505), Column Type:1st Column: GPC Guard Column (Agilent Technologies, Inc., Santa Clara, Calif., U.S., Part Number PL1110-1520), Particle Size —5 μm, Length: 50 mm×7.5 mm, 1st Column: PLGel 5μm MIXED-C, Part Number—PL1110-6500, Particle Size—5 μm, Length: 300 mm×7.5 mm, 2nd Column: OligoPore (Agilent Technologies, Inc., Santa Clara, Calif., U.S., Part Number PL1113-6520), Particle Size—6 μm, Pore Type—100A, Length: 300 mm×7.5 mm.

An Agilent 1100 HPLC with an Agilent 1260 Refractive Index detector was used for GPC analysis (Agilent Technologies, Inc., Santa Clara, Calif., U.S.). The mobile phase used was tetrahydrofuran stabilized with BHT preservative (Mollickrodt Pharmaceuticals, Inc., Staines-upon-Thames, England, UK). The stationary phase consisted of three columns from Agilent: PLgel MIXED guard column (5 micron, 7.5×300 mm, Agilent Technologies, Inc., Santa Clara, Calif., U.S.), PLgel Mixed C Column (5 micron, 7.5×300 mm, Agilent Technologies, Inc., Santa Clara, Calif., U.S.), and an OligoPore GPC column (5 micron, 7.5×300 mm, Agilent Technologies, Inc., Santa Clara, Calif., U.S.).

The calibrants used were monodisperse polystyrene standards with a molecular weight (MW) range from 580 to 4,000,000 although peaks for polystyrene dimer, trimer tetramer, and pentamer, were also observed and included in the calibration. Analytical grade toluene was used as flow marker. A fourth-degree polynomial equation was used to find the best fit for the Log MW versus the observed retention time. The instrument parameters used for calibration and sample analysis include a flow rate of 1.0 ml/min, injection volume of 50 microliters while the columns and RI detector were heated at 30° C. Samples were prepared by dissolving 25 mg of the sample into 10 ml of THF with BHT, after which 10 microliters of toluene was added as the flow marker. Samples were analyzed to determine the Mw, Mn, and Mz of the thermoplastic resins. The percent thermoplastic resin below 300 g/mol and below 600 g/mol, including the amount below 300 g/mol, was determined by GPC integration with Agilent GPC/SEC Software Version 1.2.3182.29519.

The instrument parameters used for calibration and sample analysis include a flow rate of 1.0 ml/min, injection volume of 50 microliters while the columns and RI detector were heated at 30° C. Samples were prepared by dissolving 25 mg of the sample into 10 ml of THF with BHT, after which 10 microliters of toluene was added as the flow marker. Samples were analyzed to determine the Mw, Mn, and Mz of the thermoplastic resins.

For acid titration of intermediates, the sample was weighed, and 25 mL of dimethyl formamide (DMF) is added followed by 25 mL of methanol after dissolution with stirring. The solution was allowed to stir for about 1 min, and ten drops of bromothymol blue solution (Fluka Chemie AG, now Sigma-Aldrich, St. Louis, Mo., U.S.), were added. The solution was titrated using 0.01 M sodium methylate in methanol until past equivalence point (both visually and using the calculation).

### Example 3. Synthesis of TMCD Polyester Polyol (EX2515-189)

A 2-L kettle with a four-neck lid was equipped with a mechanical stirrer, a thermocouple, a heated partial condenser (115° C.), a Dean-Stark trap, and a chilled condenser (15° C.). The kettle was charged with 2,2,4,4-tetramethylcyclobutane-1,3-diol (TMCD) (427.9 g), 2-methyl-1,3-propanediol (MPDiol) (178.3 g), trimethylolpropane (TMP) (72.01 g), isophthalic acid (IPA) (581.5 g), adipic acid (AD) (219.2 g), and the acid catalyst, Fascat-4100 (Arkema Inc.) (1.89 g). The mixture was allowed to react under a nitrogen blanket. The temperature was ramped up from room temperature to 140° C. over 80 minutes. Once reaching the meltdown temperature of 140° C., the temperature was increased from 140 to 230° C. over 2.25 hours. Once the maximum temperature was reached, the subsurface nitrogen sparge was initiated and the temperature held until a low acid number was achieved. The resin was sampled for acid number analysis with a final target of <5 mgKOH/g. After achieving an acid number of 4.2 and high viscosity, the resin was allowed to cool to 190° C. before being poured into aluminum pans. The resin was cooled and a solid product collected.

Using the same method as above, a series of resins having various glass transition temperatures (Tg's) was synthesized. The compositions of the synthesized polyesters are listed in Table 6, and the resin properties are listed in Table 7, in which CHDA is 1,4-cyclohexanedicarboxylic acid, Mn is number average molecular weight, and Mw is weight average molecular weight.

TABLE 6
Resin Compositions of TMCD Polyesters with Various Tg's

| | Resin Composition as Charged | | | | | | | |
|---|---|---|---|---|---|---|---|---|
| | | | | Eq. Ratio Based on | | | | |
| | Eq. Ratio Based on | | | Total diacids (%) | | | | eq ratio of |
| Notebook | Total diols & triol (%) | | | | | | Dimer | OH/COOH |
| Number | TMCD | MPDiol | TMP | IPA | CHDA | AD | Acid | (R) |
| EX4198-027 | 45.0 | 45.0 | 10.0 | | | 100.0 | | 1.30 |
| EX3449-021 | 43.0 | 43.0 | 14.0 | 50.0 | | 30.0 | 20.0 | 1.30 |
| EX3449-016 | 43.0 | 43.0 | 14.0 | 50.0 | | 30.0 | 20.0 | 1.20 |
| EX2515-181 | 43.0 | 43.0 | 14.0 | 70.0 | | 25.0 | 5.0 | 1.15 |
| EX2515-190 | 43.0 | 43.0 | 14.0 | 70.0 | | 30.0 | | 1.15 |
| EX2515-189 | 51.6 | 34.4 | 14.0 | 70.0 | | 30.0 | | 1.15 |
| EX2515-200 | 55.0 | 35.0 | 10.0 | 70.0 | | 30.0 | | 1.15 |
| EX2515-167 | 43.0 | 43.0 | 14.0 | 70.0 | 30.0 | | | 1.15 |
| EX2515-171 | 51.6 | 34.4 | 14.0 | 100.0 | | | | 1.15 |
| EX2515-172 | 60.2 | 25.8 | 14.0 | 100.0 | | | | 1.15 |
| EX2515-174 | 86.0 | | 14.0 | 100.0 | | | | 1.15 |

TABLE 7
Resin Properties of TMCD Polyesters with Various Tg's

| | Resin Properties | | | | |
|---|---|---|---|---|---|
| Notebook | Acid Number | OH Number | | | |
| Number | Analyzed | Analyzed | Tg, C. | Mn | Mw |
| EX4198-027 | <1.0 | 92.8 | −42.00 | 2579 | 6876 |
| EX3449-021 | 4.0 | 88.8 | −21.1 | 2296 | 6231 |
| EX3449-016 | 1.8 | 58.5 | −13.5 | 4345 | 15532 |
| EX2515-181 | 3.1 | 53.1 | 21.4 | 4612 | 41445 |
| EX2515-190 | 2.1 | 50.1 | 30.4 | 5406 | 62233 |
| EX2515-189 | 3.1 | 49.2 | 36.3 | 5042 | 56060 |
| EX2515-200 | 6.1 | 53.7 | 38.0 | 4477 | 41765 |
| EX2515-167 | 7.4 | 45.9 | 55.2 | 4676 | 46763 |
| EX2515-171 | 7.2 | 48.4 | 74.8 | 4957 | 38786 |
| EX2515-172 | 9.0 | 44.1 | 83.9 | 4676 | 46763 |
| EX2515-174 | 23.4 | 46.1 | 105.7 | 2902 | 17327 |

### Example 4. Synthesis of All-Aliphatic TMCD Polyester Polyols

Using the same method as described in Example 3, three all-aliphatic polyesters were prepared using hexahydrophthalic anhydride (HHPA) as the diacid. Their compositions and properties are listed in Table 8.

TABLE 8
All-Aliphatic TMCD Polyesters

| | Polyester Resin Composition as Charged | | | | | | | | | |
|---|---|---|---|---|---|---|---|---|---|---|
| | Eq. Ratio Based on | | | | | Resin Properties | | | | |
| | Total diols & triol (%) | | | Diacid | eq ratio of | | OH | Tg, | | |
| Polyester | NPG | TMCD | TMP | HHPA | OH/COOH | AN | # | C. | Mn | Mw |
| EX4198-108 | 45 | 45 | 10 | 100 | 1.4 | 1.4 | 124.7 | 29.74 | 1428 | 2415 |
| EX4198-114 | 42.5 | 42.5 | 15 | 100 | 1.4 | 2.0 | 129.9 | 28.82 | 1381 | 2499 |
| EX4198-117 | 34 | 51 | 15 | 100 | 1.4 | 1.0 | 118.8 | 35.47 | 1497 | 2780 |

### Example 5. Synthesis of TMCD Polyester Diols

Using the same method as described in Example 3, a series of polyester diols was prepared. These polyesters are linear without a branching agent such as TMP; thus, they have only two OH functional groups. The polyesters except the first one (EX4198-140) have the same compositions but decreasing R value (equivalent ratio of total OH/total COOH) from 1.3 to 1.1, which leads to increasing molecular weights. The compositions and the resin properties of the synthesized polyesters are listed in Table 9.

TABLE 9
TMCD Polyester Diols with Various Molecular Weights

| | Resin Composition as Charged | | | | | | | | | |
|---|---|---|---|---|---|---|---|---|---|---|
| | Eq. Ratio Based on | | | Eq. Ratio Based on | | eq ratio | | | | |
| Notebook | Total Alcohols (%) | | | Total Acids (%) | | OH/COOH | Acid | Tg, | | |
| Number | TMCD | NPG | MPDiol | AD | IPA | (R) | Number | C. | Mn | Mw |
| EX4198-140 | 50 | 50 | | 100 | | 1.3 | <0.5 | −40.4 | 1586 | 3082 |
| EX2515-118 | 50 | | 50 | | 100 | 1.3 | <1.0 | 40.3 | 1650 | 2975 |
| EX2515-119 | 50 | | 50 | | 100 | 1.25 | <1.0 | 47.9 | 2007 | 4017 |
| EX2515-120 | 50 | | 50 | | 100 | 1.2 | 3.5 | 51 | 1915 | 4061 |
| EX2515-121 | 50 | | 50 | | 100 | 1.15 | 5.3 | 59.5 | 2791 | 5752 |
| EX2515-122 | 50 | | 50 | | 100 | 1.1 | 8.2 | 67 | 3276 | 7961 |

### Example 6. Preparation of Solvent-Borne Adhesive

A polyester polyol solution (30% solids) is first prepared by mixing polyester EX3449-021 in ethyl acetate. An adhesive is then prepared by mixing the polyester polyol solution with each silane functionalized resin prepared in Example 1 at an equivalent ratio of OH/alkoxy=1/3. The resulting adhesive is then applied to a polymer film substrate. After the solvent is evaporated, the coated film is laminated with another polymer film. The laminated films are then tested for peel strength over a period of 7 days at room temperatures or slightly elevated temperatures (e.g. 30-50° C.). Such an adhesive has utilities in, for example, flexible packaging, auto interior, and wood working.

### Example 7. Preparation of hot melt Adhesive

A prepolymer is prepared by mixing polyester polyol EX2515-120 with each silane functionalized resin prepared in Example 1 at an equivalent ratio of OH/alkoxy=1/3 at 80° C. After cooling, the resulting solid prepolymer is used as a moisture-curable hot melt adhesive. The adhesive is heated to 120° C., and the melt is applied to a polymer film and subsequently laminated with another polymer film. The laminated films are then tested for peel strength over a period of 7 days at room temperatures or slightly elevated temperatures (e.g. 30-50° C.). Such a hot melt adhesive has utilities in, for example, building & construction, automotive, and wood working.

It is understood that the foregoing description is that of the preferred embodiments of the invention and that various changes and modifications may be made thereto without departing from the spirit and scope of the invention as defined in the appended claims.

What is claimed is:

1. A curable adhesive composition comprising:
a hydroxyl functional polymer, and
a silane functionalized resin,
wherein the hydroxyl functional polymer has a hydroxyl number of 10 mgKOH/g to 200 mgKOH/g and number average molecular weight of 500 g/mol to 10,000 g/mole, and
wherein said silane functional hydrocarbon resin is represented by the structure of:
Resin-[Zk-Xn-R1−(CH2)m-Si(R2)p]q
wherein:
Z is an aromatic group or an aliphatic group;
X is a linker comprising a heteroatom selected from sulfur, oxygen, nitrogen, a carbonyl group, or a combination thereof;
R1 comprises one or more of an aliphatic and/ or aromatic C1 to C₁₈ and/or a linkage group comprising a heteroatom;
each R2 is the same or different and is independently selected from a Cl to C₁₈ alkoxy, aryloxy, alkyl, aryl, or H, or OH, and is optionally branched, and at least one R2 is C1 to C₁₈ alkoxy, aryloxy, or H, or OH;
q is an integer from of at least 1;
k is an integer of 0 or 1;
n is an integer from 1 to 10;
m is an integer from 0 to 10;
p is 1, 2, or 3; and
wherein the silane functionalized resin forms a Si—O—C covalent bond with the hydroxyl functional polymer upon curing of said adhesive.

2. The curable adhesive composition of claim 1, wherein Z comprises a heteroatom.

3. The curable adhesive composition of claim 1, wherein composition:
possesses a peel strength of 5 N/25mm or greater as measured in accordance with ASTM D1876 (T-peel test) or ISO 4587,
possesses a lap shear strength of 1 N/mm2 or greater as measured in accordance with ASTM D1002, or
possesses an offline bond strength of from 100 grams per 25 mm to 1000 grams per 25 mm as measured in accordance with ASTM F904-16, after the curable adhesive composition is fully cured between two substrates.

4. The curable adhesive composition of claim 1, wherein:
the hydroxyl functional polymer is present in an amount of 30 weight % to 90 weight % and
the silane functionalized resin is in an amount of 10 weight % to 70 weight %, based on the total weight.

5. The curable adhesive composition of claim 1, wherein the hydroxyl functional polymer is one or more of polyester polyol, polyether polyol, and acrylic polyol.

6. The curable adhesive of claim 1, further comprising an organic solvent.

7. The curable adhesive of claim 1, wherein the composition is a hot melt adhesive.

8. The curable adhesive composition of claim 1, wherein the composition is cured.

9. The curable adhesive composition of claim 1, wherein the hydroxyl functional polymer comprises hydroxyl groups, and wherein the hydroxyl groups are present in the composition in a ratio of 0.7 to 1.3 with respect to silane groups.

10. The curable adhesive composition of claim 8, wherein curing comprises hydrolysis of alkoxy groups on silane groups in the silane functionalized resin to yield silanol groups, and condensation reaction with hydroxyl groups on the hydroxyl functional polymer to form Si—O—C covalent bonds or with other silanol groups to form Si—O—Si covalent bonds.

11. The curable adhesive composition of claim 5, wherein the hydroxyl functional polymer is the polyester polyol and further comprises at least one diol, at least one diacid, and/or at least one polyol.

12. The curable adhesive composition of claim 11, wherein the at least one diol is one or more of 2,2,4,4-tetramethyl-1,3-cyclobutanediol (TMCD), 2,2-dimethyl-1,3-propanediol (neopentyl glycol), 1,2 cyclohexane-dimethanol, 1,3-cyclohexanedimethanol, 1,4 cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, tetraethylene glycol, polyethylene glycol, and 2,2-bis(hydroxymethyl)propionic acid (dimethylolpropionic acid).

13. The curable adhesive composition of claim 11, wherein the at least one diol is one or more of 2,2,4,4-tetramethyl-1,3-cyclobutanediol (TMCD), 2,2-dimethyl-1, 3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 1,4-butanediol, and 1,6-hexanediol.

14. The curable adhesive composition of claim 11, wherein the at least one polyol is one or more of 1,1,1-trimethylolpropane (TMP), 1,1,1-trimethylolethane, glycerin, pentaerythritol, erythritol, threitol, dipentaerythritol, and sorbitol.

15. The curable adhesive composition of claim 11, wherein the at least one diacid is selected from one or more of a dimethyl ester, a dialkyl ester, a diacid halide, or an acid anhydride.

16. The curable adhesive composition of claim 11, wherein the at least one diacid is one or more of isophthalic acid (or dimethyl isophthalate), terephthalic acid (or dimethyl terephthalate), phthalic acid, phthalic anhydride, 1,4 cyclohexane-dicarboxylic acid, 1,3 cyclohexanedicarboxylic acid, hexahydrophthalic anhydride, tetrahydrophthalic anhydride, tetrachlorophthalic anhydride, dodecanedioic acid, sebacic acid, azelaic acid, maleic acid or anhydride, fumaric acid, succinic anhydride, succinic acid, adipic acid, dimer acid, hydrogenated dimer acid, 2,6 naphthalenedicarboxylic acid, glutaric acid, itaconic acid, and their derivatives, diglycolic acid, 2,5-norbornanedicarboxylic acid, 1,4-naphthalenedicarboxylic acid; 2,5-naphthalenedicarboxylic acid, diphenic acid; 4,4′-oxydibenzoic acid, and 4,4′-sulfonyidibenzoic acid.

17. The curable adhesive composition of claim 1, further comprising at least one vinyl polymer selected from one or more of methyl acrylate, methyl methacrylate, ethyl acrylate, ethyl methacrylate, butyl acrylate, butyl methacrylate, isobutyl acrylate, isobutyl methacrylate, 2-ethylhexyl methacrylate, 2-ethylhexyl acrylate, isoprene, octyl acrylate, octyl methacrylate, iso-octyl acrylate, iso-octyl methacrylate, isobornyl (meth)acrylate, cyclohexyl (meth)acrylate, hydroxymethyl (meth)acrylate, hydroxyethyl (meth)acrylate, hydroxypropyl (meth)acrylate, hydroxylbutyl (meth)acrylate, acetoacetoxy ethyl methacrylate, acetoacetoxy ethyl acrylate, methyl 2-(hydroxymethyl)acrylate, ethyl 2-(hydroxymethyl)acrylate, isopropyl 2-(hydroxymethyl)acrylate, n-butyl 2-(hydroxymethyl)acrylate, t-butyl 2-(hydroxymethyl)acrylate, vinyl ester such as vinyl acetate, vinyl alcohol, vinyl ether, styrene, alkylstyrene, butadiene, and acrylonitrile.

18. An article comprising the composition of claim 1, wherein the article is a laminate, a tape, a tag, a radio frequency identification (RFID) tag, a sealant, a flexible or non-flexible film, a foam, a potting compound, a disposable hygiene article, a fiberglass reinforced plastic, a motor vehicle molded part, a motor vehicle extruded part, a motor vehicle laminated part, a furniture part, a fabric, or a woven textile.
